(19) United States
(12) Patent Application Publication
(10) Pub. No.: US 2025/0139033 A1
(43) Pub. Date: May 1, 2025

(54) MEMORY CHIP AND MEMORY SYSTEM WITH THE SAME

(71) Applicant: Etron Technology, Inc., Hsinchu (TW)

(72) Inventor: Chun Shiah, Hsinchu City (TW)

(21) Appl. No.: 19/008,669

(22) Filed: Jan. 3, 2025

Related U.S. Application Data
(63) Continuation-in-part of application No. 16/904,597, filed on Jun. 18, 2020.
(60) Provisional application No. 62/910,468, filed on Oct. 4, 2019.
(60) Provisional application No. 63/007,960, filed on Apr. 10, 2020.
(60) Provisional application No. 63/617,744, filed on Jan. 4, 2024.
(60) Provisional application No. 63/555,406, filed on Feb. 20, 2024.
(60) Provisional application No. 63/564,512, filed on Mar. 13, 2024.

(51) Int. Cl. G06F 13/20

(52) U.S. Cl. CPC G06F 13/20; G06F 2213/16

(57) ABSTRACT

A memory chip includes a plurality of memory banks, an I/O data bus, and a plurality of align circuits. Each memory bank outputs or receives a data set in parallel. The plurality of align circuits correspond to the plurality of memory banks respectively. The data set of one memory bank is transferred to one corresponding align circuit which then simultaneously transfers the data set to the I/O data bus in parallel, or the data set is transferred from the I/O data bus to the one corresponding align circuit which then simultaneously transfers the data set to the one memory bank in parallel. There is no parallel-to-serial circuit and serial-to-parallel circuit between the I/O data bus and each memory banks.

### CROSS REFERENCE TO RELATED APPLICATIONS

This application is a continuation-in-part of U.S. application Ser. No. 16/904,597, filed on Jun. 18, 2020, which claims the benefit of U.S. Provisional Application No. 62/910,468, filed on Oct. 4, 2019, and claims the benefit of U.S. Provisional Application No. 63/007,960, filed on Apr. 10, 2020. Further, this application claims the benefit of U.S. Provisional Application No. 63/617,744, filed on Jan. 4, 2024. Further, this application claims the benefit of U.S. Provisional Application No. 63/555,406, filed on Feb. 20, 2024. Further, this application claims the benefit of U.S. Provisional Application No. 63/564,512, filed on Mar. 13, 2024. The contents of these applications are incorporated herein by reference.

### BACKGROUND OF THE INVENTION

### 1. Field of the Invention

The present invention relates to a memory chip and a memory system, and particularly to a memory chip and a memory system that can let wide bus data be simultaneously transmitted between a logic circuit and the memory chip in parallel to reduce powers, accessing latencies, and cost of the memory chip, and increase bandwidth of an IO data bus and a data rate of the memory chip.

### 2. Description of the Prior Art

Nowadays, a memory system for high performance computing or artificial intelligence (AI) system usually includes dynamic random access memory (DRAM) chips and a logic circuit. Due to stacked structures of the DRAM chips, scaling of the DRAM chips cannot follow scaling of the logic circuit. Therefore, a memory-wall effect occurs to result in data transmission rates between the logic circuit and the DRAM chips being reduced. To overcome the memory-wall effect, the prior art usually 1) utilizes faster data rate (e.g., from DDR3 to DDR4 or DDR5) to transmit data between the DRAM chips and the logic circuit, or 2) utilizes wide data bus of the logic circuit and wide data bus of the DRAM chips (e.g. HBM) to transmit data between the DRAM chips and the logic circuit. However, the faster data rate has disadvantages (e.g. more expensive tester, less noise margin, and so on), and the wide data bus of the logic circuit and the wide data bus of the DRAM chips also have disadvantages (e.g. higher power, larger die area, and expensive Through-Silicon Via (“TSV”) process, and so on). And no matter the aforesaid faster data rate of the DRAM or the wider data bus of the DRAM, all need serial-to-parallel circuit and parallel-to-serial circuit which increases clock latencies and power consumption.

Please refer to FIG. 1. FIG. 1 is a diagram illustrating a memory system 10 according to the prior art. As shown in FIG. 1, the memory system 10 includes a memory 20 and a logic circuit 30, wherein the memory 20 is a dynamic random access memory (DRAM). As shown in FIG. 1, the memory 20 includes cell arrays 21, a parallel-to-serial circuit 22, and a serial-to-parallel circuit 23; the logic circuit 30 includes a physical layer (PHY) 31 and a controller 32, and the physical layer 31 also includes a serial-to-parallel circuit 312, and a parallel-to-serial circuit 314. In addition, of course, the logic circuit 30 further includes other functional circuits (not shown in FIG. 1), wherein the other functional circuits can include central processing units (CPUs), digital signal processors (DSPs), peripheral interfaces, and so on. As shown in FIG. 1, when the logic circuit 30 writes data into the memory 20, the parallel-to-serial circuit 314 can receive the data (e.g. N-bit data) from the controller 32 in parallel, convert the N-bit data into groups of Q-bit data, wherein Q is less than N, and transmit the groups of Q-bit data to the serial-to-parallel circuit 23; the serial-to-parallel circuit 23 can receive the groups of Q-bit data from the parallel-to-serial circuit 314, convert groups of Q-bit data into the N-bit data, and transmit the N-bit data to the cell arrays 21 in parallel. In addition, when the logic circuit 30 reads the data from the memory 20, the parallel-to-serial circuit 22 can receive the data (e.g. the N-bit data) from the cell arrays 21 in parallel, convert the N-bit data into the groups of Q-bit data, and transmit the groups of Q-bit data to the serial-to-parallel circuit 312; the serial-to-parallel circuit 312 can receive the groups of Q-bit data from the parallel-to-serial circuit 22, convert the groups of Q-bit data into the N-bit data, and transmit the N-bit data to the controller 32 in parallel.

Please refer to FIG. 2A, FIG. 2B. FIG. 2A, FIG. 2B are diagrams illustrating timing diagrams corresponding to the logic circuit 30 writing the data into the memory 20. As shown in FIG. 2A, taking the logic circuit 30 writing 8-bit data D0-D7 into the memory 20 as an example, when the logic circuit 30 writes the 8-bit data D0-D7 into the memory 20, registers (not shown in FIG. 1) of the parallel-to-serial circuit 314 may use three signals clk1, clk2, clk3 to transmit the parallel 8-bit data D0-D7 to the serial-to-parallel circuit 23 in serial. For example, when clk1=1, clk2=1, clk3=1, the parallel-to-serial circuit 314 transmits the datum D0 to the serial-to-parallel circuit 23, when clk1=1, clk2=1, clk3=0, the parallel-to-serial circuit 314 transmits the datum D1 to the serial-to-parallel circuit 23 . . . , and so on. Therefore, the parallel-to-serial circuit 314 starts to transmit the datum D0 at a time T0, and finally transmit the datum D7 at a time T4.

As shown in FIG. 2B, similarly, registers (not shown in FIG. 1) of the serial-to-parallel circuit 23 may also use similar clock signals clk1, clk2, clk3 to process 8-bit data D0-D7 in serial from the parallel-to-serial circuit 314. As shown in FIG. 2B, when clk1=1, clk2=1, clk3=1, the serial-to-parallel circuit 23 receives the datum DO from the parallel-to-serial circuit 314, when clk1=1, clk2=1, clk3=0, the serial-to-parallel circuit 23 receives the datum D1 from the parallel-to-serial circuit 314 . . . , and so on). Therefore, the serial-to-parallel circuit 23 starts to receive the datum D0 at a time T0, and finally receives the datum D7 at a time T4, wherein 4 clock latencies of the clock clk3 exist between the time T0 and the time T4. That is, the serial-to-parallel circuit 23 only starts to transmit the 8-bit data D0-D7 to the cell arrays 21 in parallel after the serial-to-parallel circuit 23 waits for the 4 clock latencies.

Although the prior art can reduce the 4 clock latencies (e.g. 3.5 clock latencies) by optimizing the memory system 10, the above-mentioned serial-to-parallel converting process executed by the serial-to-parallel circuit 23 and the above-mentioned parallel-to-serial converting process executed by the parallel-to-serial circuit 314 would cost extra power, transmission latencies, and die areas, result in low efficiencies of the memory system 10. Therefore, how to reduce cost of the power, transmission latencies, and die areas becomes an important issue for a designer of the memory system.

### SUMMARY OF THE INVENTION

An embodiment of the present invention provides a memory chip. The memory chip includes a plurality of memory banks, an I/O data bus, and a plurality of align circuits. Each memory bank outputs or receives a data set in parallel. The plurality of align circuits correspond to the plurality of memory banks respectively. The data set of one memory bank is transferred to one corresponding align circuit which then simultaneously transfers the data set to the I/O data bus in parallel, or the data set is transferred from the I/O data bus to the one corresponding align circuit which then simultaneously transfers the data set to the one memory bank in parallel. There is no parallel-to-serial circuit and serial-to-parallel circuit between the I/O data bus and each memory banks.

According to one aspect of the invention, each align circuit includes a first plurality of transceivers which connect to the I/O data bus through a direct sending/receiving bus, and a width of the I/O data bus equals to a width of the data set outputting from or receiving by each memory bank.

According to one aspect of the invention, a plurality of the data set of the plurality of memory banks are outputted to the I/O data bus in a predetermined sequence.

According to one aspect of the invention, the data set of each memory bank are shared with a common row address, and a column address for the data set of each memory bank are different from each other.

According to one aspect of the invention, the column address for the data set of each memory bank is generated by the memory chip internally, or received from a memory controller external to the memory chip.

According to one aspect of the invention, the plurality of the data set of the plurality of memory banks are outputted to the I/O data bus within a bit switch cycle which includes a plurality of phases, and the data set of each memory bank is outputted to the I/O data bus at a corresponding phase of the bit switch cycle.

According to one aspect of the invention, the plurality of phases of the bit switch cycle includes 2N phases, and a clock period of a clock signal of the memory chip equals to the bit switch cycle divided by 2N−1, and N is an integer not less than 1.

According to one aspect of the invention, a number of the plurality of phases of the bit switch cycle is set in a mode register in the memory chip.

According to one aspect of the invention, the memory chip further includes data lines and a plurality set of sensing amplifiers. The plurality set of sensing amplifiers are coupled to the data lines, wherein the one memory bank corresponds to one set of sensing amplifiers, and the corresponding set of sensing amplifiers is installed between the one memory bank and the corresponding align circuit.

According to one aspect of the invention, the plurality of memory banks include a first memory bank and a second memory bank; the plurality set of sensing amplifiers include a first set of sensing amplifiers coupled to the data lines and a second set of sensing amplifiers coupled to the data lines; the first set of sensing amplifiers corresponds to the first memory bank, and a first data set is simultaneously transferred between the first set of sensing amplifiers and the I/O data bus in parallel through and an align circuit corresponding to the first memory bank; the second set of sensing amplifiers corresponds to the second memory bank, and a second data set is simultaneously transferred between the second set of sensing amplifiers and the I/O data bus in parallel through another align circuit corresponding to the second memory bank; a width of the I/O data bus equals to a width of the first data set and a width of the second data set.

According to one aspect of the invention, a width of a Dfi (DDR PHY Interface) bus of a physical layer circuit of a logic circuit equals to a sum of the width of the first data set and the width of the second data set, wherein the Dfi bus is coupled between a controller within the logic circuit and the physical layer circuit, the controller is further coupled to an AXI (Advanced extensible Interface) bus outside the logic circuit, and the logic circuit is coupled to the I/O data bus of the memory chip.

According to one aspect of the invention, the memory chip further includes bit lines, a third set of sensing amplifiers, and a fourth set of sensing amplifiers. The third set of sensing amplifiers are coupled to the bit lines and configured between the first memory bank and the first set of sensing amplifiers. The fourth set of sensing amplifiers are coupled to the bit lines and configured between the second memory bank and the second set of sensing amplifiers.

According to one aspect of the invention, the memory chip further includes a first bit switch set and a second bit switch set. The first bit switch set is between the first plurality of sensing amplifiers and the third plurality of sensing amplifiers. The second bit switch set is between the second plurality of sensing amplifiers and the fourth plurality of sensing amplifiers.

Another embodiment of the present invention provides a memory system. The memory system includes a memory chip and a logic circuit. The memory chip includes a plurality of memory banks, an I/O data bus, and a plurality of align circuits. Each memory bank outputs or receives a data set in parallel. The plurality of align circuits correspond to the plurality of memory banks respectively. The data set of one memory bank is transferred to one corresponding align circuit which then simultaneously transfers the data set to the I/O data bus in parallel, or the data set is transferred from the I/O data bus to the one corresponding align circuit which then simultaneously transfers the data set to the one memory bank in parallel. There is parallel-to-serial no circuit and serial-to-parallel circuit between the I/0 data bus and each memory banks. The logic circuit has a physical layer circuit, wherein the logic circuit is external to and electrically connected to the I/O data bus of the memory chip, and a parallel-to-serial circuit and a serial-to-parallel circuit are located within the physical layer circuit.

According to one aspect of the invention, the physical layer circuit further includes a second plurality of transceivers electrically connected to the parallel-to-serial circuit and the serial-to-parallel circuit.

According to one aspect of the invention, the plurality of memory banks includes 2N banks, N is an integer not less than 1, and the parallel-to-serial circuit is a 2N:1 parallel-to-serial circuit, and the serial-to-parallel circuit is a 1:2N serial-to-parallel circuit.

According to one aspect of the invention, a Dfi bus of the physical layer circuit equals to a sum of the width of the data set of each memory bank of the memory chip, wherein the Dfi bus is coupled between a controller within the logic circuit and the physical layer circuit.

According to one aspect of the invention, each align circuit includes a first plurality of transceivers which connect to the I/O data bus through a direct sending/receiving bus, and a width of the I/O data bus equals to a width of the data set outputting from or receiving by each memory bank.

According to one aspect of the invention, a plurality of the data set of the plurality of memory banks are outputted to the I/O data bus in a predetermined sequence.

According to one aspect of the invention, the data set of each memory bank are shared with a common row address, and a column address for the data set of each memory bank are different from each other.

According to one aspect of the invention, the column address for the data set of each memory bank is generated by the memory chip internally, or received from a memory controller external to the memory chip.

According to one aspect of the invention, the plurality of the data set of the plurality of memory banks are outputted to the I/O data bus within a bit switch cycle which includes a plurality of phases, and the data set of each memory bank is outputted to the I/O data bus at a corresponding phase of the bit switch cycle.

According to one aspect of the invention, the plurality of phases of the bit switch cycle includes 2N phases, and a clock period of a clock signal of the memory chip equals to the bit switch cycle divided by 2N−1, and N is an integer not less than 1.

According to one aspect of the invention, a number of the plurality of phases of the bit switch cycle is set in a mode register in the memory chip.

According to one aspect of the invention, the memory system further includes a second memory chip, wherein the second memory chip includes a second plurality of memory banks, an I/O data bus, and a plurality of align circuits. Each memory bank outputs or receives a data set in parallel. The plurality of align circuits correspond to the second plurality of memory banks respectively. The data set of one memory bank of the second memory chip is transferred to one corresponding align circuit which then simultaneously transfers the data set to the I/O data bus in parallel, or the data set of the one memory bank of the second memory chip is transferred from the I/O data bus to the one corresponding align circuit which then simultaneously transfers the data set to the one memory bank of the second memory chip in parallel. There is no parallel-to-serial circuit and serial-to-parallel circuit between the I/O data bus and each memory bank of the second memory chip. A plurality of the data set of the plurality of memory banks of the first memory chip are outputted to the I/O data bus of the first memory chip within a bit switch cycle which comprises 2N phases, and the data set of each memory bank of the first memory chip is outputted to the I/O data bus of the first memory chip at a corresponding phase of the bit switch cycle, and a clock period of a clock signal of the first memory chip equals to the bit switch cycle divided by 2N−1, and N is an integer not less than 1. The plurality of the data set of the second plurality of memory banks of the second memory chip are outputted to the I/O data bus of the second memory chip within the bit switch cycle which comprises 2N−1 phases, and the data set of each memory bank of the second memory chip is outputted to the I/O data bus of the second memory chip at a corresponding phase of the bit switch cycle, and a clock period of a clock signal of the second memory chip equals to that of the first memory chip.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a memory system according to the prior art.

FIG. 2A, FIG. 2B are timing diagrams corresponding to the logic circuit writing the data into the memory.

FIG. 3 is a diagram illustrating a memory system according to a first embodiment of the present invention.

FIG. 4 is a diagram illustrating structures of two transceivers according to another embodiment of the present invention.

FIG. 5 is a timing diagram comparing a conventional memory system with the memory system.

FIG. 6 is a diagram illustrating an area of the memory being less than an area of the conventional memory and an area of the physical layer is also less than an area of a physical layer in the conventional logic circuit.

FIG. 7 is a diagram illustrating a data width of the memory being changed by control signals according to another embodiment of the present invention.

FIG. 8, FIG. 9 are diagrams illustrating different memories according to different embodiments of the present invention.

FIG. 10 is a diagram illustrating a memory system according to another embodiment of the present invention.

FIG. 11 is a diagram illustrating relationships between clock, column addresses, bit switch, read data and TAU of the CLK rising cell array, bit switch, read data and TAU of the CLK falling cell array, DQ, and DQS during the read cycle of the memory.

FIG. 12 is a diagram illustrating relationships between clock, column addresses, bit switch and write data of the CLK rising cell array, bit switch and write data of the CLK falling cell array.

FIG. 13 is a diagram illustrating the column addresses except the starting column address being not cared when the column addresses are generated by the internal DWB counter of the memory.

FIG. 14 is a diagram illustrating relationships between one bit switch cycle and one clock cycle when the memory has different sub-systems.

FIG. 15 is a diagram illustrating a memory with 4 sub-systems according to another embodiment of the present invention.

FIG. 16 is a diagram illustrating relationships between clock, bit switch and data of the CLK rising1 cell array, the CLK falling1 cell array, the CLK rising2 cell array and the CLK falling2 cell array during the read/write cycle of the memory.

FIG. 17 is a diagram illustrating different relationships between CLK (XCLK) and data (phase) when a memory includes different numbers of sub-systems.

FIG. 18 is a diagram illustrating relationships between CLK (XCLK) and bit switch (phase) and read data when the memory with 4 sub-systems in the read cycle.

FIG. 19 is a diagram illustrating relationships between CLK (XCLK) and bit switch (phase), DOS and write data when the memory with 4 sub-systems in the write cycle.

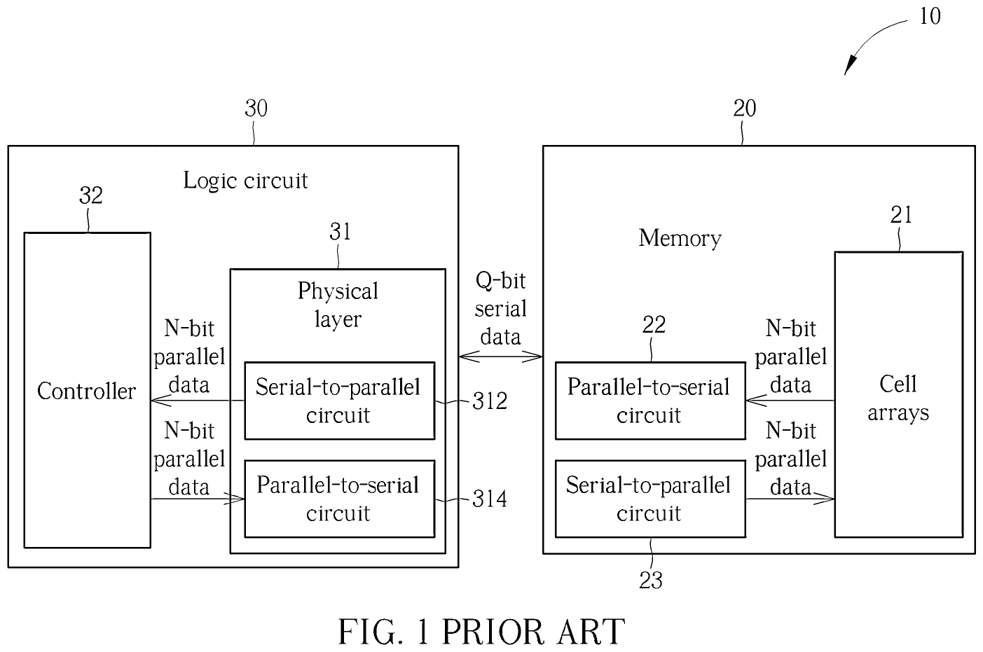

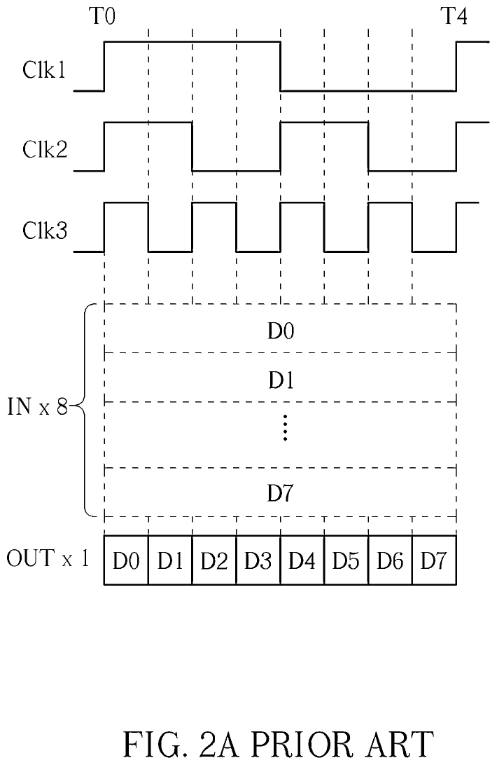

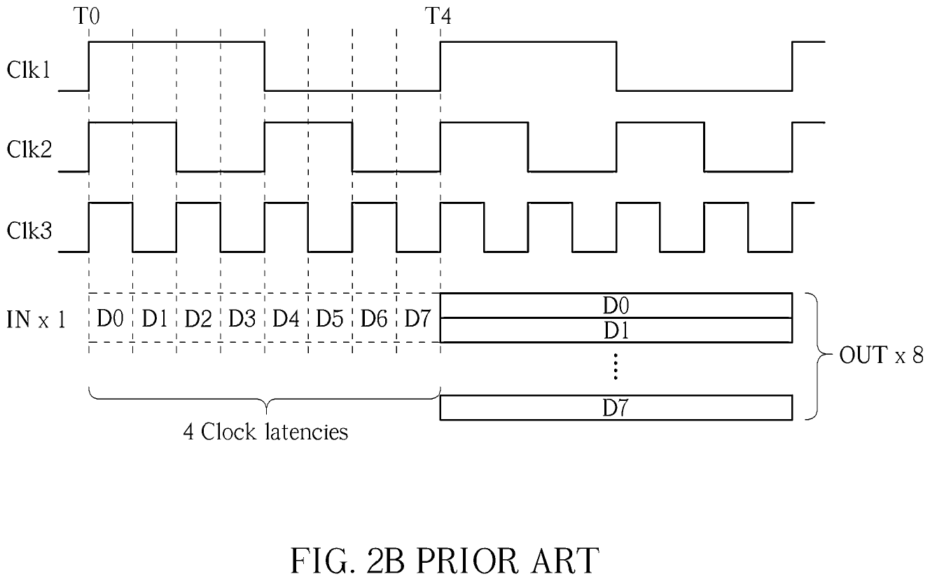

### DETAILED DESCRIPTION

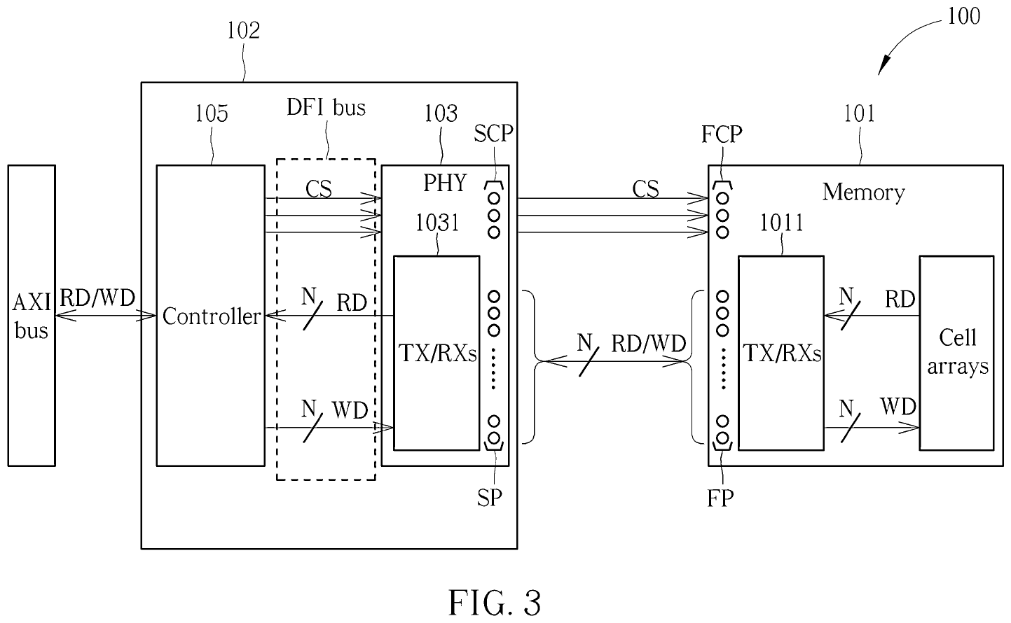

Please refer to FIG. 3. FIG. 3 is a diagram illustrating a memory system 100 according to a first embodiment of the present invention. As shown in FIG. 3, the memory system 100 includes a memory 101 and a logic circuit 102, wherein the memory 101 can be a dynamic random access memory (DRAM), a static random access memory (SRAM), a flash memory or other kinds of memories, and the logic circuit 102 can be an artificial intelligence (AI) chip or a system on chip (SOC). In addition, in one embodiment of the present invention, the memory 101 can include a base DRAM chip and a plurality of DRAM chips stacked above the base DRAM chip. In addition, the logic circuit 102 is coupled to other devices or processors through an AXI (Advanced extensible Interface) bus, wherein the AXI bus is a bus protocol, the protocol is part of the AMBA (Advanced Microcontroller Bus Architecture) 3.0 protocol. The AXI bus includes a writing data bus and a reading data bus. In addition, an operation method corresponding to the AXI bus is well-known to those of ordinary skill in the art, so further description thereof is omitted for simplicity.

The memory 101 includes a first align circuit 1011 and a plurality of first pads FP, wherein the first align circuit 1011 is used for aligning data corresponding to the memory 101, and includes a plurality of transceivers. That is, the first align circuit 1011 is used for simultaneously transmitting the data or simultaneously receiving the data (e.g. transmitting the data in a same clock or receiving the data in a same clock, that is, the plurality of transceivers of the first align circuit 1011 can transmit the data in parallel or receive the data in parallel). On the other hand, the logic circuit 102 includes a physical layer (PHY) 103 and a controller 105, wherein the physical layer 103 is electrically connected to the controller 105 through a Double Data Rate Physical Layer Interface (DDR PHY Interface, DFI) bus. The DFI bus includes a plurality of wire pairs, wherein the plurality of wire pairs include a plurality of writing wires and a plurality of reading wires. In addition, the physical layer 103 includes a second align circuit 1031 and a plurality of second pads SP, wherein the second align circuit 1031 is used for aligning the data, and also includes a plurality of transceivers. That is, the second align circuit 1031 is also used for simultaneously transmitting the data or simultaneously receiving the data (e.g. transmitting the data in a same clock or receiving the data in a same clock, that is, the plurality of transceivers of the second align circuit 1031 can transmit the data in parallel or receive the data in parallel).

In this embodiment of present invention, the first align circuit 1011 and the second align circuit 1031 can align and transmit the data in parallel, or can align and receive the data in parallel, and the data can be transmitted between the memory 101 and the logic circuit 102 without the conventional parallel-to-serial and serial-to-parallel circuits in both memory 101 and the physical layer 103. Therefore, the controller (or memory controller) 105 can utilize the plurality of wire pairs, the second align circuit 1031, the plurality of second pads SP, the plurality of first pads FP, and the first align circuit 1011 to access the data corresponding to the memory 101 in parallel. The number of the plurality of first pads FP can equal to a number of the plurality of writing wires (or a number of the plurality of reading wires) of the plurality of wire pairs of the DFI bus. Moreover, the number of the plurality of second pads SP can equal to a number of the plurality of writing wires (or a number of the plurality of reading wires) of the plurality of wire pairs of the DFI bus.

For example, as shown in FIG. 3, the number of the plurality of first pads FP or the number of the plurality of second pads SP equals N, and the data can be N-bit data RD read from cell arrays of the memory 101 or N-bit data WD written into the cell arrays of the memory 101. When the logic circuit 102 reads the N-bit data RD from the cell arrays of the memory 101 in parallel, the first align circuit 1011 receives the N-bit data RD from the cell arrays of the memory 101 in parallel and simultaneously transmits the N-bit data RD in parallel to the second align circuit 1031 through the plurality of first pads FP and the plurality of second pads SP. After the second align circuit 1031 receives the N-bit data RD in parallel, the second align circuit 1031 transmits the N-bit data RD to the controller 105 in parallel through the plurality of reading wires of the plurality of wire pairs of the DFI bus. On the other hand, when the logic circuit 102 writes the N-bit data WD into the cell arrays of the memory 101 in parallel, the second align circuit 1031 receives the N-bit data WD from the controller 105 in parallel through the plurality of writing wires of the plurality of wire pairs of the DFI bus. Then, the second align circuit 1031 simultaneously can transmit the N-bit data WD to the first align circuit 1011 in parallel not through conventional parallel-to-serial and serial-to-parallel circuits. After the first align circuit 1011 receives the N-bit data WD, the first align circuit 1011 writes the N-bit data WD into the cell arrays of the memory 101 in parallel.

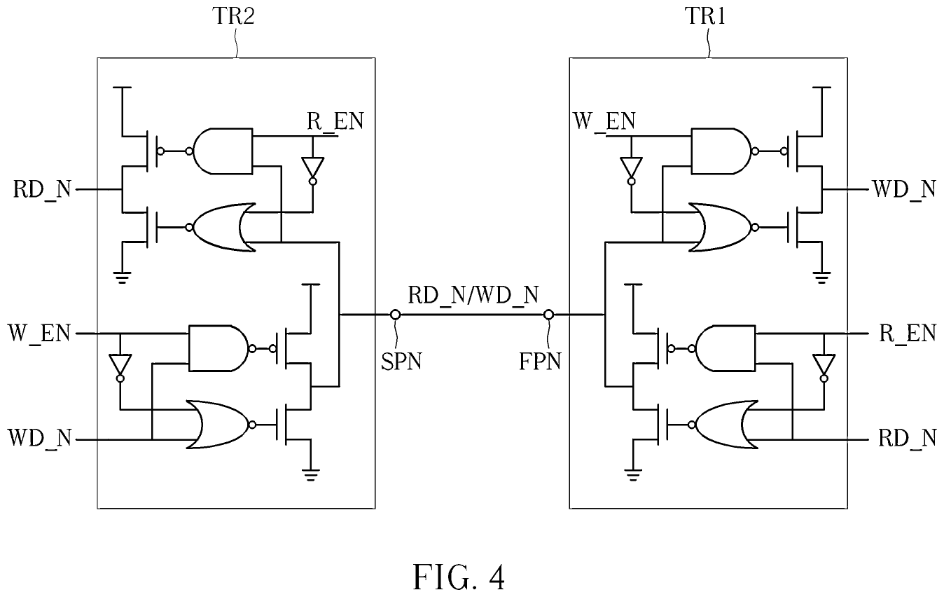

In addition, each of the first align circuit 1011 and the second align circuit 1031 comprises a plurality of transceivers, wherein each transceiver of the first align circuit 1011 is coupled to a corresponding pad of the plurality of first pads FP and each transceiver of the second align circuit 1031 is coupled to a corresponding pad of the plurality of second pads SP. Please refer to FIG. 4. FIG. 4 is a diagram illustrating structures of two transceivers TR1, TR2 according to another embodiment of the present invention, wherein each transceiver of the first align circuit 1011 (not shown in FIG. 4) can be the transceiver TR1, and each transceiver of the second align circuit 1031 (not shown in FIG. 4) can be the transceiver TR2. In addition, components of the transceivers TR1, TR2 are well-known to one of ordinary skill in the art, so further descriptions thereof are omitted for simplicity. In addition, coupling relationships between the components of the transceivers TR1, TR2 can be referred to FIG. 4, so further descriptions thereof are also omitted for simplicity. When a write enable signal W_EN is enabled and a read enable signal R_EN is disabled, the transceiver TR2 transmits a bit datum WD_N of the N-bit data WD to the transceiver TR1 through a first pad FPN and a second pad SPN. On the other hand, when the write enable signal W_EN is disabled and the read enable signal R_EN is enabled, the transceiver TR1 transmits a bit datum RD_N of the N-bit data RD to the transceiver TR2 through the first pad FPN and the second pad SPN. Because the write enable signal W_EN and the read enable signal R_EN are common signals for the first align circuit 1011 and the second align circuit 1031, the first align circuit 1011 can simultaneously transmit the N-bit data RD in parallel or receive the N-bit data WD in parallel, and the second align circuit 1031 can simultaneously transmit the N-bit data WD in parallel or receive the N-bit data RD in parallel.

In another embodiment of the present invention, a first write enable signal and a first read enable signal are signals for the first align circuit 1011, and a second write enable signal and a second read enable signal are signals for the second align circuit 1031, wherein the first write enable signal and the first read enable signal correspond to the second write enable signal and the second read enable signal, respectively.

Because the first align circuit 1011 and the second align circuit 1031 can transmit data in parallel or receive data in parallel not through conventional parallel-to-serial and serial-to-parallel circuits, the first align circuit 1011 can simultaneously transmit the N-bit data RD to the second align circuit 1031 in parallel or receive the N-bit data WD from the second align circuit 1031 in parallel, and similarly, the second align circuit 1031 can simultaneously receive the N-bit data RD from the first align circuit 1011 in parallel or transmit the N-bit data WD to the first align circuit 1011 in parallel. In addition, as shown in FIG. 4, the present invention is not limited to each transceiver of the first align circuit 1011 being the transceiver TR1 and each transceiver of the second align circuit 1031 being the transceiver TR2. That is, each transceiver of the first align circuit 1011 and each transceiver of the second align circuit 1031 can be other transmitting/receiving circuits, buffers or registers.

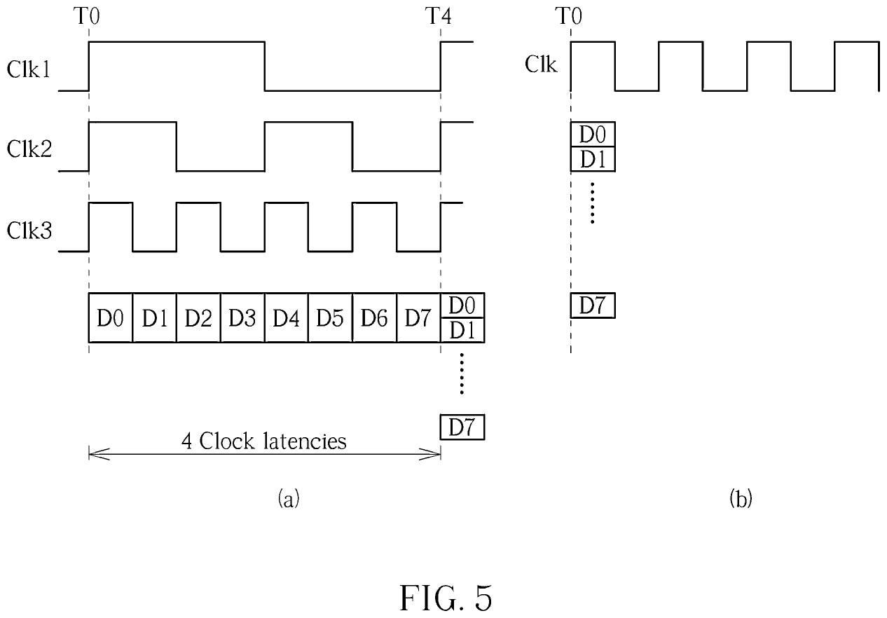

Please refer to FIG. 5. FIG. 5 is a timing diagram for comparing a conventional memory system with the memory system 100. For example, as shown in FIG. 5(a), when a conventional logic circuit reads 8-bit data D0-D7 from a conventional memory, the conventional memory needs to utilize three clocks clk1, clk2, clk3 to form 8 statuses, such that the 8-bit data D0-D7 can be transmitted in serial (for example, datum D0 corresponds to status (clk1=1, clk2=1, clk3=1), datum D1 corresponds to status (clk1=1, clk2=1, clk3=0) . . . and so on). Therefore, a controller of the conventional logic circuit can only start to receive the data D0-D7 until a time T4 in parallel. However, as shown in FIG. 5(b), because the data D0-D7 are transmitted simultaneously by the memory 101, the controller 105 can start to receive the data D0-D7 at a time T0. Therefore, compared to the conventional memory system, the present invention can save 4 clock latencies. In addition, operation method of writing the 8-bit data D0-D7 is similar to the above-mentioned operation methods, so further descriptions thereof are omitted for simplicity.

Please refer to FIG. 3 again. As shown in FIG. 3, the controller 105 is further coupled to the physical layer 103 through a plurality of control wires, the physical layer 103 further includes a plurality of second control pads SCP, the memory 101 further includes a plurality of first control pads FCP, and the plurality of first control pads FCP are electrically connected to the plurality of second control pads SCP. Therefore, the controller 105 can utilize the plurality of control wires, the plurality of second control pads SCP, and the plurality of first control pads FCP to transmit control signals CS to the memory 101. In addition, FIG. 3 only shows three first control pads, three second control pads, and three control wires, but the present invention is not limited thereto. In addition, the plurality of control wires and the plurality of wire pairs between the physical layer 103 and the controller 105 are included in the DFI bus, wherein the DFI bus defines signals, timing parameters, and programmable parameters required for communications between the physical layer 103 and the controller 105. Therefore, the control signals CS are defined by the DFI bus and can include, for example, write enable signal, read enable signal, and chip select signal. In addition, an operation method corresponding to the DFI bus is well-known to those of ordinary skill in the art, so further description thereof is omitted for simplicity. In addition, the logic circuit 102 in another embodiment may further includes system circuits (not shown in FIG. 3), wherein the system circuits can include other peripheral interfaces. The controller or memory controller 105 communicates with the system circuits through an Advanced extensible Interface (AXI) bus. For example, the controller 105 can transmit the N-bit data RD to the system circuits or receive the N-bit data WD from the system circuits through the AXI bus to other devices or processors.

In addition, the plurality of first pads FP can be electrically connected to the plurality of second pads SP by metal wires, metal bridges, flip-chip, micro-bump, or other bonding technologies. In addition, in another embodiment of the present invention, because the plurality of first pads FP are electrically connected to the plurality of second pads SP, the plurality of first pads FP and the plurality of second pads SP are not coupled to environment outside the memory system 100. Therefore, the plurality of first pads FP and the plurality of second pads SP do not need to include conventional electrostatic discharge (ESD) protection circuits, and sizes of the plurality of first pads FP and the plurality of second pads SP can be reduced.

In another embodiment of the present invention, the second align circuit 1031 of the physical layer 103 can be applied to different data width which is depending on a data width of the AXI bus. However, in another embodiment of the present invention, both the second align circuit 1031 of the physical layer 103 and the first align circuit 1011 of the memory 101 can be applied simultaneously to different data width which depends on the data width of the AXI bus. For example, when the logic circuit 102 is applied to a memory with Q-bit data width, the controller 105 can inform the physical layer 103 to adjust the second align circuit 1031 to make the second align circuit 1031 only utilize Q reading wires of the plurality of wire pairs to transmit Q-bit data to the controller 105 (or utilize Q writing wires of the plurality of wire pairs to receive Q-bit data from the controller 105), wherein Q is a positive integer greater than 1 and less than N. Therefore, the physical layer 103 and the controller 105 can be applied to different system circuits and different memories with the different data width.

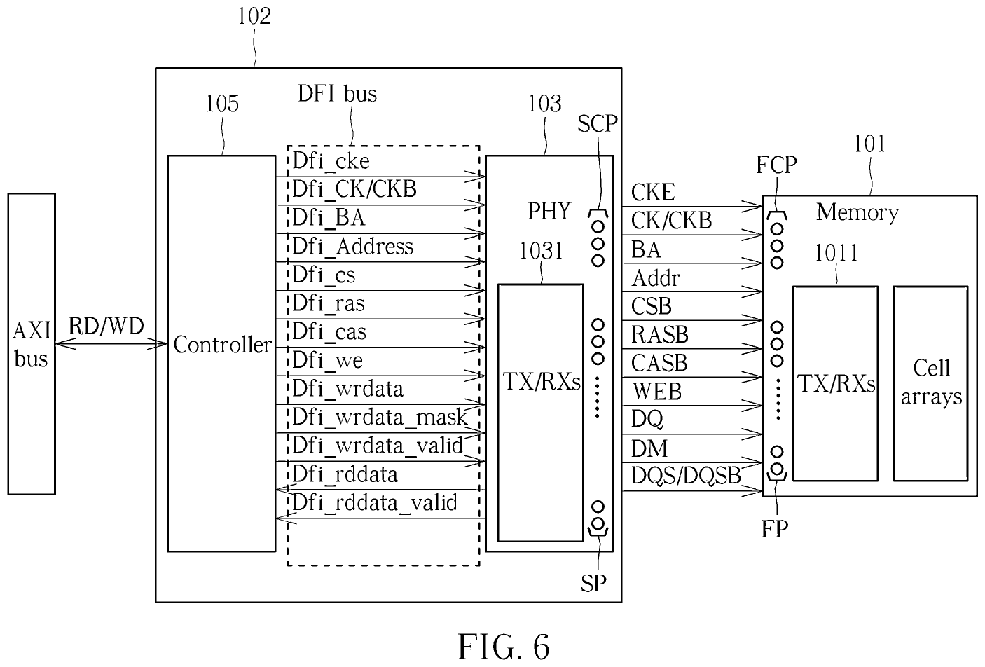

Because the first align circuit 1011 and the second align circuit 1031 are smaller and simpler, and the conventional parallel-to-serial and serial-to-parallel circuits are omitted from the memory 101 and the physical layer 103, reading/writing speed of the memory 101 are significantly increased, an area of the memory 101 is less than an area of the conventional memory and an area of the physical layer 103 is also is less than an area of a physical layer in the conventional logic circuit (as shown in FIG. 6), and a memory-wall problem between the memory 101 and the logic circuit 102 can be reduced. In addition, the physical layer 103 can receive signals of DFI cke, DFI CK/CKB, DFI BA, DFI address, DFI cs, DFI_ras, DFI cas, DFI we, DFI wrdata, DFI wrdata mask, DFI wrdata valid from the controller 105 and transmit signals of DFI rddata, DFI rddata valid to the controller 105 through the DFI bus, wherein the signals of DFI cke, DFI CK/CKB, DFI BA, DFI address, DFI cs, DF_ras, DFI cas, DFI we, DFI wrdata, DFI wrdata mask, DFI wrdata valid and the signals of DFI rddata, DFI rddata valid are well-defined in DFI specification, so further descriptions thereof are omitted for simplicity. In addition, the physical layer 103 can transmit signals of CKE, CK/CKB, BA, Addr, CSB, RASB, CASB, WEB, DQ, DM, DQS/DQSB to the memory 101, wherein the signals of CKE, CK/CKB, BA, Addr, CSB, RASB, CASB, WEB, DQ, DM, DQS/DQSB are also well-defined in DFI specification, so further descriptions thereof are omitted for simplicity. Therefore, the plurality of first pads FP can be electrically connected to the plurality of second pads SP even if the memory 101 and the logic circuit 102 are made by heterogeneous processes. For example, transistors of the memory 101 can be planar or trench transistors adopted by current memory technologies (e.g. DRAM or HBM technologies) while transistors of the logic circuits 102 can be 3D transistors (e.g. tri-gate transistors, fin field-effect transistors (FinFETs), or gate-all-around transistors). However, in another embodiment of the present invention, the memory 101 and the logic circuit 102 are made by homogeneous processes. That is, the memory 101 and the logic circuit 102 can adopt the planar or trench transistors, the tri-gate transistors, the FinFETs, gate-all-around transistors, or other transistors. Moreover, powers of the memory 101 and the logic circuits 102 are saved, latencies of accessing the memory 101 are reduced, and cost of areas of the memory 101 and the logic circuits 102 are decreased by adopting the first align circuit 1011 and the second align circuit 1031, rather than adopting the conventional parallel-to-serial and serial-to-parallel circuits. Therefore, reading/writing window margins of the memory system 100 are improved.

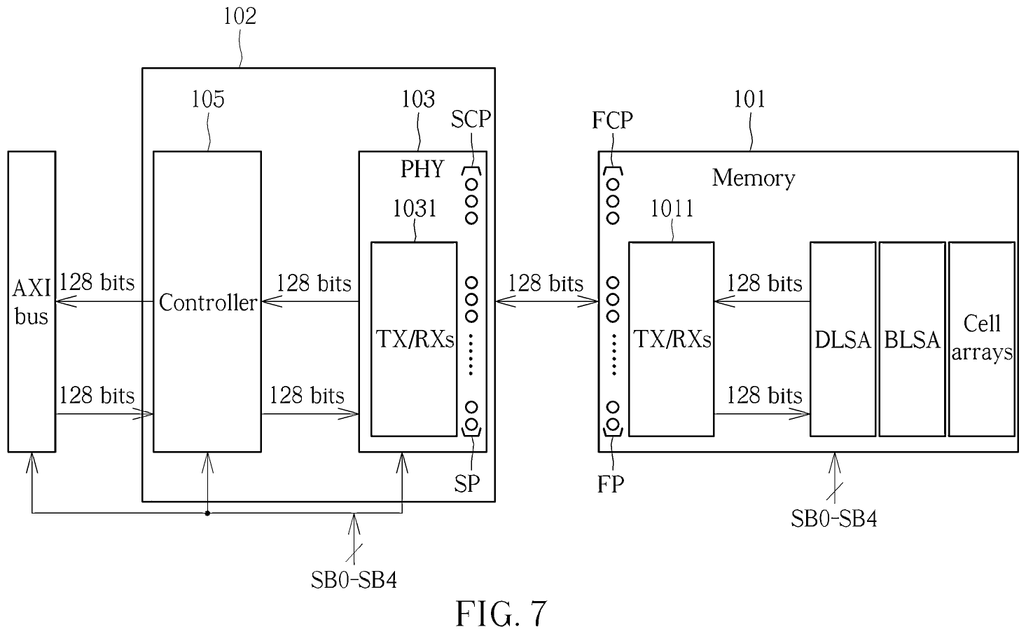

In addition, please refer to FIG. 7. FIG. 7 is a diagram illustrating a data width of the memory being changed by control signals according to another embodiment of the present invention. For example (but not limited), the memory 101 includes M second sensing amplifiers BLSA (i.e. bit line sensing amplifiers) and N first sensing amplifiers DLSA (i.e. data line sensing amplifiers), wherein a connected number of the M second sensing amplifiers BLSA electrically coupled to the first sensing amplifiers DLSA can be changed by control signals (such as SB0-SB4 according to TABLE 1), the second sensing amplifiers BLSA are between the cell arrays and the first sensing amplifiers DLSA, the first sensing amplifiers are between the second sensing amplifiers BLSA and the first align circuit 1011 which includes the plurality of transceivers, the first align circuit 1011 is between the first sensing amplifiers DLSA and an I/O data bus (not shown in FIG. 7) of the memory 101, N is a positive integer and not greater than M, and the I/O data bus is coupled to the plurality of first pads FP.

In one embodiment, the control signals are stored in a register (not shown in FIG. 7) of the memory 101, such as mode registers. In addition, the second sensing amplifiers BLSA are connected to bit lines (not shown in FIG. 7) of the memory 101, and the first sensing amplifiers DLSA are connected to data lines (not shown in FIG. 7) of the memory 101. The N first sensing amplifiers DLSA are electrically coupled to part of the M second sensing amplifiers BLSA through a plurality of bit switches, and those bit switches could be selected or activated by the aforesaid control signals.

As shown in TABLE 1 and FIG. 7, when the control signals SB0-SB4 are 0/0/0/0/1, 128 second sensing amplifiers are electrically coupled to 128 first sensing amplifiers through bit switches (not shown in FIG. 7, a group of selected bit switches, such as 128 or less bit switches based on ONE given column address, are selected by the control signals SB0-SB4 (0/0/0/0/1)), 128 bits data can be read from the cell arrays of the memory 101 through part of the second sensing amplifiers and the first sensing amplifiers (such as through the 128 connected second sensing amplifiers and the 128 first sensing amplifiers), or written into the cell arrays of the memory 101 by the first align circuit 1011 through part of the second sensing amplifiers and the first sensing amplifiers (such as through the 128 connected second sensing amplifiers and the 128 first sensing amplifiers). That is, when the 128 bits data are read from the cell arrays of the memory 101, the plurality of transceivers of the first align circuit 1011 parallelly receive and transmit the 128 bits data from the 128 first sensing amplifiers to the I/O data bus of the memory 101, or when the 128 bits data are written into the cell arrays of the memory 101, the plurality of transceivers of the first align circuit 1011 parallelly receive and transmit the 128 bits data from the I/O data bus to the 128 first sensing amplifiers. Or in other words, when the 128 bits data are read from the cell arrays of the memory 101, part of the second sensing amplifiers BLSA (such as the 128 connected second sensing amplifiers) output the 128 bits data to the first sensing amplifiers DLSA (such as the 128 first sensing amplifiers) which then parallelly output the 128 bits data to the plurality of transceivers, or when the 128 bits data are written into the cell arrays of the memory 101, the 128 first sensing amplifiers parallelly output the 128 bits data to part of the connected second plurality of sensing amplifiers (such as the 128 second sensing amplifiers BLSA). In addition, a data width of the memory 101 (i.e. a width of the I/O data bus of the memory 101) is equal to 128 according to the 128 first sensing amplifiers. Meanwhile, because the data width of the memory 101 is equal to 128, both a data width of the controller 105 and the data width of the AXI bus are equal to 128.

In another embodiment of the present invention, a read (or write) data width of the DFI bus coupled to physical layer 103 are also equal or set to 128 according to the control signals SB0-SB4. In addition, as shown in FIG. 7, when the logic circuit 102 is included in a computing system with a system bus interface (i.e. the AXI bus) which includes a read data bus and a write data bus, both a width of the read data bus and a width of the write data bus are equal to 128 according to the control signals SB0-SB4 (0/0/0/0/1) inputted to the controller 105. In addition, a width of the DFI bus is selectively adjusted according to the control signals SB0-SB4 (0/0/0/0/1) inputted to the physical layer 103.

Similarly, as shown in TABLE 1 and FIG. 7, when the control signals SB0-SB4 are 0/0/0/1/0, 256 second sensing amplifiers of the M second sensing amplifiers are electrically coupled to 256 first sensing amplifiers through another group of selected bit switches (such as 256 or less bit switches based on ONE given column address), so the data width of the memory 101 is limited to be equal to 256 according to the 256 first sensing amplifiers; when the control signals SB0-SB4 are 0/0/0/1/1, 512 second sensing amplifiers of the M second sensing amplifiers are electrically coupled to 512 first sensing amplifiers through other selected bit switches (such as 512 or less bit switches based on ONE given column address), so the data width of the memory 101 is limited to be equal to 512 according to the 512 first sensing amplifiers; when the control signals SB0-SB4 are 0/0/1/0/0, 1024 second sensing amplifiers of the M second sensing amplifiers are electrically coupled to 1024 first sensing amplifiers through other selected bit switches (such as 1024 or less bit switches based on ONE given column address), so the data width of the memory 101 is limited to be equal to 1024 according to the 1024 first sensing amplifiers; and when the control signals SB0-SB4 are 0/0/0/0/0, 64 second sensing amplifiers of the M second sensing amplifiers are electrically coupled to 64 first sensing amplifiers through selected bit switches (such as 64 or less bit switches based on ONE given column address), so the data width of the memory 101 is limited to be equal to 64 according to the 64 first sensing amplifiers. In addition, the present invention is not limited to the memory 101 including the M second sensing amplifiers and configurations of the control signals SB0-SB4 shown in FIG. 7. In addition, the present invention is also not limited to a number of the control signals SB0-SB4, that is, the present invention can have a number of control signals less than or more than the number of the control signals SB0-SB4.

TABLE 1

| | The data | The data | The data |
|---|---|---|---|
| | width of the | width of the | width of the |
| SB4/SB3/SB2/SB1/SB0 | memory 101 | controller 105 | AXI bus |
| 0/0/1/0/0 | 1024 | 1024 | 1024 |
| 0/0/0/1/1 | 512 | 512 | 512 |
| 0/0/0/1/0 | 256 | 256 | 256 |
| 0/0/0/0/1 | 128 | 128 | 128 |
| 0/0/0/0/0 | 64 | 64 | 64 |

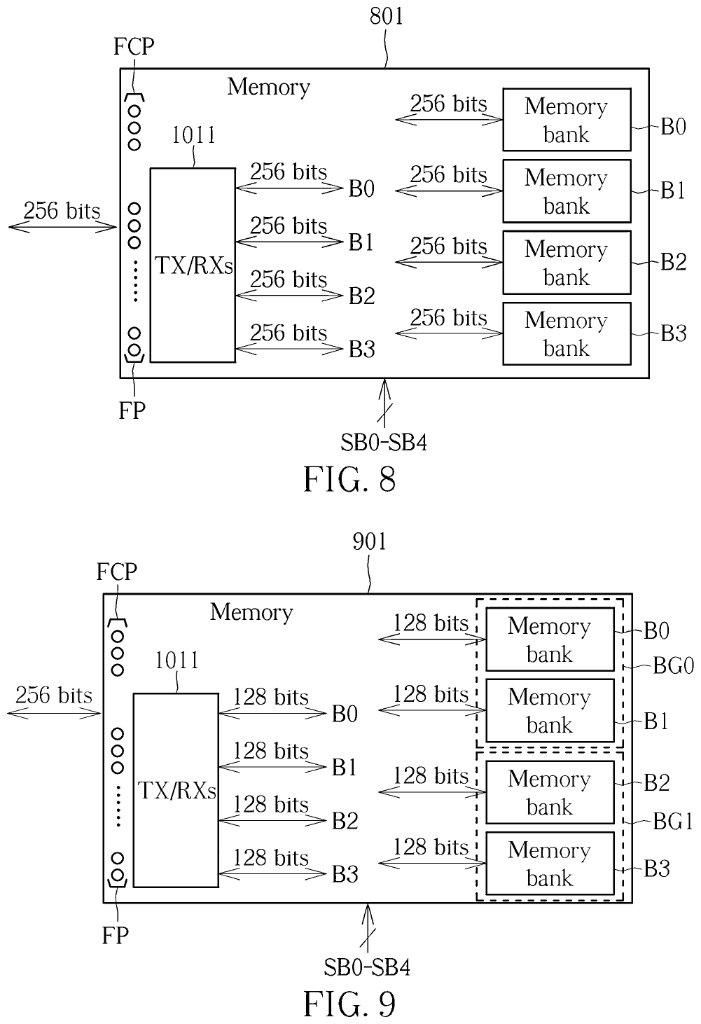

In addition, please refer to FIG. 8. FIG. 8 is a diagram illustrating a memory 801 according to another embodiment of the present invention, wherein a difference between the memory 801 and the memory 101 is that the memory 801 includes 4 memory banks B0-B3, each memory bank of the memory banks B0-B3 is just the cell arrays of the memory 101. But, the present invention is not limited to the memory 801 including the 4 memory banks B0-B3 (that is, the memory 801 can include a plurality of memory banks). In addition, for simplicity, the M second sensing amplifiers BLSA and the N first sensing amplifiers DLSA are not shown in FIG. 8.

As shown in TABLE 2 and FIG. 8, when the control signals SB0-SB4 are 0/0/0/1/0, 256 second sensing amplifiers of a specific memory bank of the memory 801 could be electrically coupled to 256 first sensing amplifiers by the control signals SB0-SB4, so 256 bits data can be read from the specific memory bank of the memory 801 by the first align circuit 1011 through the 256 connected second sensing amplifiers and the 256 first sensing amplifiers, or written into the specific memory bank of the memory 801 by the first align circuit 1011 through the 256 connected second sensing amplifiers and the 256 first sensing amplifiers. The specific memory bank of the memory 801 could be selected by another signal, such as bank selected signals. That is, as shown in TABLE 2, a data width of the selected memory bank of the memory 801 could be adjusted to be equal to 256 according to the 256 first sensing amplifiers. In addition, because the 4 memory banks B0-B3 are independent of each other, a data width of the memory 801 (i.e. a width of the I/O data bus of the memory 801) is also equal to 256. In addition, in another embodiment both the data width of the controller 105 and the data width of the DFI bus are equal to 256 according to the control signals SB0-SB4 (0/0/0/1/0)

In addition, other data widths of the each memory bank of the memory 801 and other data widths of the memory 801 corresponding to the control signals SB0-SB4 (0/0/1/0/0), (0/0/0/1/1), (0/0/0/0/1), (0/0/0/0/0) can be referred to TABLE 2, so further descriptions thereof are omitted for simplicity. In addition, the present invention is not limited to configurations of the control signals SB0-SB4 shown in FIG. 8.

TABLE 2

| | The data | The data width | The data |
|---|---|---|---|
| | width of the | of the each | width of the |
| SB4/SB3/SB2/SB1/SB0 | AXI bus | memory bank | memory 801 |
| 0/0/1/0/0 | 1024 | 1024 | 1024 |
| 0/0/0/1/1 | 512 | 512 | 512 |
| 0/0/0/1/0 | 256 | 256 | 256 |
| 0/0/0/0/1 | 128 | 128 | 128 |
| 0/0/0/0/0 | 64 | 64 | 64 |

In addition, please refer to FIG. 9. FIG. 9 is a diagram illustrating a memory 901 according to another embodiment of the present invention, wherein a difference between the memory 901 and the memory 801 is that the memory banks B0, B1 are included in a bank group BG0, and the memory banks B2, B3 are included in a bank group BG1. But, the present invention is not limited to the bank group BG0 including the memory banks B0, B1, and the bank group BG1 including the memory banks B2, B3. For example, all banks B0, B1, B2, B3 could be grouped as a bank group BGX.

Taking the bank group BG0 as an example, a first set of sensing amplifiers coupled to the data lines and a second set of sensing amplifiers coupled to the data lines, wherein the first set of sensing amplifiers corresponds to the memory bank B0 and is configured to parallelly output a first plurality of data, the second set of sensing amplifiers corresponds to the memory bank B1 and configured to parallelly output a second plurality of data, and the first set of sensing amplifiers and the second set of sensing amplifiers are just the previously mentioned first sensing amplifiers (that is, DLSA). In addition, a third set of sensing amplifiers is coupled to the bit lines and configured between the memory bank B0 and the first set of sensing amplifiers, and a fourth set of sensing amplifiers is coupled to the bit lines and configured between the memory bank B1 and the second set of sensing amplifiers, wherein the third set of sensing amplifiers and the fourth set of sensing amplifiers are just the previously mentioned second sensing amplifiers (that is, BLSA).

Therefore, as shown in TABLE 3 and FIG. 9, when the control signals SB0-SB4 are 0/1/0/1/0, 128 second sensing amplifiers corresponding to each memory bank of a specific bank group (e.g. the bank group BG0) are electrically coupled to 128 first sensing amplifiers corresponding to the each memory bank of the specific bank group by the control signals SB0-SB4, so 256 bits data can be read from the specific bank group by the first align circuit 1011 through 256 connected second sensing amplifiers and 256 first sensing amplifiers (because the first align circuit 1011 can read 128 bits data of the 256 bits data from one memory bank of the specific bank group through 128 connected second sensing amplifiers and 128 first sensing amplifiers corresponding to the one memory bank, and read other 128 bits data of the 256 bits data from another memory bank of the specific bank group through other 128 connected second sensing amplifiers and other 128 first sensing amplifiers corresponding to the another memory bank), or the 256 bits data can be written into the specific bank group by the first align circuit 1011 through the 256 connected second sensing amplifiers and the 256 first sensing amplifiers (because the first align circuit 1011 can write the 128 bits data of the 256 bits data to the one memory bank of the specific bank group through the 128 connected second sensing amplifiers and the 128 first sensing amplifiers corresponding to the one memory bank, and write the other 128 bits data of the 256 bits data to the another memory bank of the specific bank group through the other 128 connected second sensing amplifiers and the other 128 first sensing amplifiers corresponding to the another memory bank). That is, as shown in TABLE 3, a data width of each memory bank of the specific bank group are limited to be equal to 128 according to the 128 first sensing amplifiers. In addition, because the memory banks B0, B1 are included in the bank group BG0, a data width of the memory 901 (i.e. a width of the I/O data bus of the memory 901) is equal to a sum (i.e. 128+128=256) of data width of all memory banks of the specific bank group. And the available banks will be reduced to half, as compared to FIG. 8.

In addition, other data widths of the each memory bank of the memory 901 and other data widths of the memory 901 corresponding to the control signals SB0-SB4 (0/1/0/0/0), (0/1/0/0/1), (0/1/0/1/1), (0/0/0/0/0) can be referred to TABLE 3, so further descriptions thereof are omitted for simplicity. In addition, the present invention is not limited to configurations of the control signals SB0-SB4 shown in FIG. 9.

TABLE 3

| | The data | The data | The data width |
|---|---|---|---|
| | width of the | width of the | of the each |
| SB4/SB3/SB2/SB1/SB0 | AXI bus | memory 801 | memory bank |
| 0/1/0/0/0 | 1024 | 1024 | 512 |
| 0/1/0/0/1 | 512 | 512 | 256 |
| 0/1/0/1/0 | 256 | 256 | 128 |
| 0/1/0/1/1 | 128 | 128 | 64 |
| 0/0/0/0/0 | 64 | 64 | 32 |

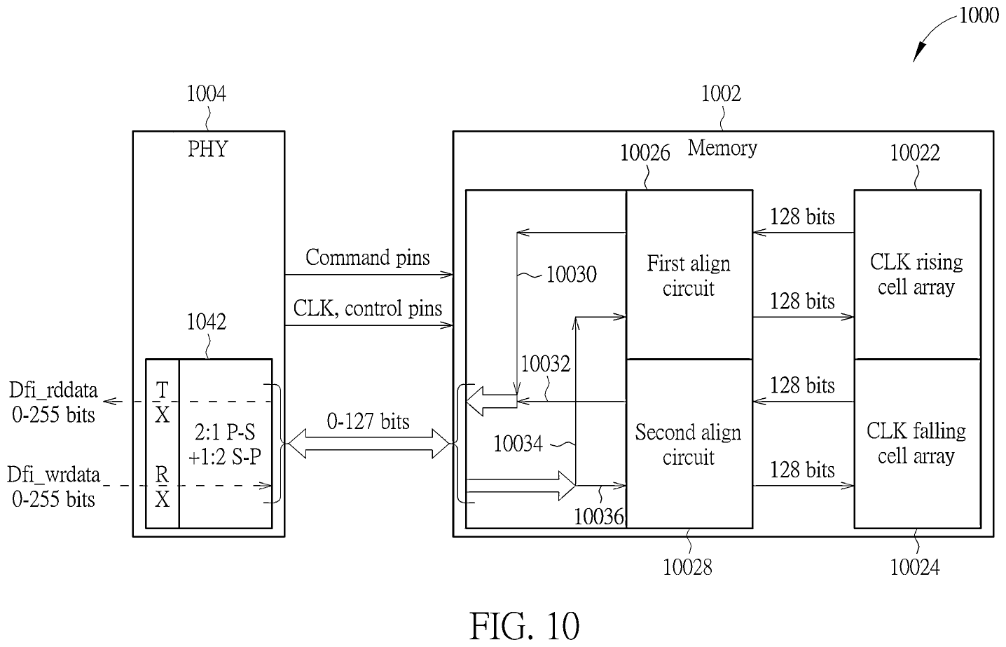

Please refer to FIG. 10. FIG. 10 is a diagram illustrating a memory system 1000 according to another embodiment of the present invention, wherein the memory system 1000 includes a memory chip 1002 and a PHY 1004, and the memory chip 1002 is an advanced DWB (direct interface wide bus) memory with combination of clock (CLK) rising sub-system (a CLK rising cell array 10022 (e.g. BANK 0)) and CLK falling sub-system (a CLK falling cell array 10024 (e.g. BANK 1)) to increase bandwidth or performance in some address specific applications, wherein there are 2 phases per bit switch cycle. In addition, the PHY 1004 is included in a logic circuit (not shown in FIG. 10), and the logic circuit can be referred to the logic circuit 102 in FIG. 7. The memory system 1000 can be applied for memory chip with different data width (e.g. 32, 64, 128, 256, 512 . . . ) in each cell array, and the memory system 1000 takes 128 bits as example. The CLK rising cell array 10022 can send 128 bits data to or receive 128 bits data from a first align circuit 10026 at CLK rising edges in parallel, and the CLK falling cell array 10024 can also send 128 bits data to or receive 128 bits data from a second align circuit 10028 at CLK falling edges in parallel, wherein the CLK rising cell array 10022 samples commands, address, data and operates from CLK rising edges of the CLK signal, and the CLK falling cell array 10024 samples commands, address, data and operates from CLK falling edges of the CLK signal. In addition, the first align circuit 10026 and the second align circuit 10028 have simple DFI read/write data alignment (either by CLK rising or by a replica data path from CLK rising) function, wherein functions of the first align circuit 10026 and the second align circuit 10028 are the same as the first align circuit 1011 shown in FIG. 7, so further descriptions thereof are omitted for simplicity. For example, each of the first align circuit 10026 and the second align circuit 10028 includes a plurality of transceivers. As shown in FIG. 10, because the CLK rising cell array 10022 operates at CLK rising edges, and the CLK falling cell array 10024 operates at CLK falling edges, width of the I/O data bus (not shown in FIG. 10) of the memory chip 1002 is still 128 bits, therefore, the pin numbers of the memory chip 1002 will not dramatically increase. In addition, as shown in FIG. 10, the memory chip 1002 further includes a first direct sending data bus 10030, a second direct sending data bus 10032, a first direct receiving data bus 10034, and a second direct receiving data bus 10036, wherein the first align circuit 10026 sends 128 bits data to the I/O data bus or receive 128 bits data from the I/O data bus through the first direct sending data bus 10030 and the first direct receiving data bus 10034 respectively, and the second align circuit 10028 sends 128 bits data to the I/O data bus or receive 128 bits data from the I/O data bus through the second direct sending data bus 10032 and the second direct receiving data bus 10036 respectively. Just the same as FIG. 7, in this embodiment, no serial-to-parallel circuit and parallel-to-serial circuit is required between the CLK rising cell array 10022 (or its corresponding data line sense amplifiers) and the I/O data bus (or I/O pads), and no serial-to-parallel circuit and parallel-to-serial circuit is required between the CLK falling cell array 10024 (or its corresponding data line sense amplifiers) and the I/O data bus (or I/O pads).

In one embodiment, the 128 bits data from the CLK rising cell array 10022 and the 128 bits data from the CLK falling cell array 10024 are shared the same row address. In addition, because the CLK rising cell array 10022 can send 128 bits data to or receive 128 bits data from the first align circuit 10026 at CLK rising edges, and the CLK falling cell array 10024 can also send 128 bits data to or receive 128 bits data from the second align circuit 10028 at CLK falling edges, the CLK rising cell array 10022 and the CLK falling cell array 10024 can have their corresponding column addresses which are assigned based on application requirements, wherein a few examples are shown as follows:
1) The CLK rising cell array 10022 can store even column address data while the CLK falling cell array 10024 can store odd column address data (or VICE VERSA).
2) Or different address assignment like the CLK rising cell array 10022 stores column addresses corresponding to the BANK 0 (i.e. column address B2=0 or B5=0 for the CLK rising cell array 10022), while the CLK falling cell array 10024 stores column addresses corresponding to the BANK 1 (i.e. column address B2=1 or B5=1 for the CLK falling cell array 10024). That is, any combination of address with CLK rising/CLK falling sub systems falls within the scope of the present invention.

Because the CLK rising cell array 10022 can send 128 bits data to or receive 128 bits data from the I/O data bus of the memory chip 1002 at CLK rising edges through the first align circuit 10026, and the CLK falling cell array 10024 can send 128 bits data to or receive 128 bits data from the I/O data bus of the memory chip 1002 at CLK falling edges through the second align circuit 10028, an align circuit 1042 included in the PHY 1004 needs 2:1 serial-to-parallel circuit and parallel-to-serial circuit (or 2:1 multiplexer) to process (such as receive from or send to the memory chip 1002) 256 bits data. For example, in read cycle of the memory chip 1002, during one CLK period (including one CLK rising edge and one CLK falling edge), the align circuit 1042 can combine 128 bits data from the CLK rising cell array 10022 and 128 bits data from the CLK falling cell array 10024 to generate 256 bits DFI_rddata to the AXI bus (shown in FIG. 7) through the controller 105 (shown in FIG. 7), and in write cycle of the memory chip 1002, during one CLK period (including one CLK rising edge and one CLK falling edge), the align circuit 1042 can receive 256 bits DFI_wrdata from the AXI bus through the controller 105 to transmit 128 bits data to the CLK rising cell array 10022 (the BANK 0) at CLK rising edge of the one CLK period and 128 bits data to the CLK falling cell array 10024 (the BANK 1) at CLK falling edge of the same CLK period. Therefore, the align circuit 1042 still needs 2:1 parallel-to-serial circuit (2:1 P-S), 1:2 serial-to-parallel circuit (1:2 S-P), and 256 transceivers (TXRX).

Besides the serial-to-parallel circuit and parallel-to-serial circuit, the align circuit 1042 also has additional simple read/write data alignment (either aligned by DQS or by CLK signal or by others) function, wherein such alignment functions of the align circuit 1042 are the same as the second align circuit 1031 shown in FIG. 7, so further descriptions thereof are also omitted for simplicity. Therefore, the memory chip 1002 maintains the same width (i.e. 128 bits) of data and the same width (i.e. 128 bits) of bits in both the CLK rising cell array 10022 (the BANK 0) and the CLK falling cell array 10024 (the BANK 1), but the PHY 1004 can receive from and send to the controller 105 (shown in FIG. 7) 256 bits data width. Therefore, without increasing the pin numbers of the memory chip 1002, the bus width for the controller 105 or the logic circuit 102 will be double.

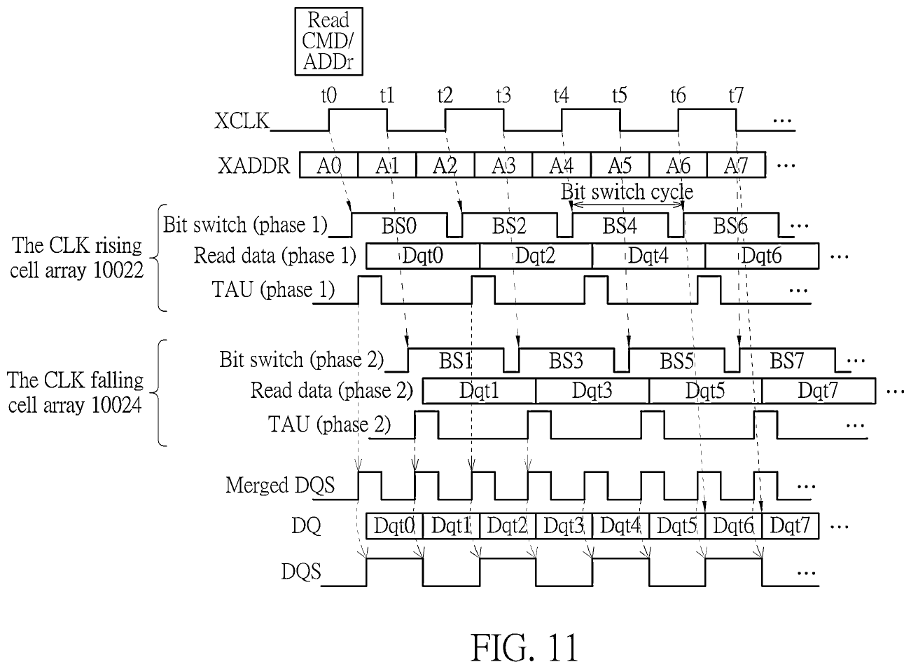

Next, the read cycle and the write cycle of the memory chip 1002 will be described in detail. In the embodiment shown in FIG. 11, one CLK period equals to one bit switch cycle with two phases, wherein one bit switch cycle could be Ins to 4 ns depending array architecture.

The read cycle:

As shown in FIG. 11, after the memory chip 1002 receives read command/addresses, the CLK rising cell array 10022 can utilizes CLK (XCLK) to sample the read command/addresses to make bit switches BS0, BS2, BS4, BS6 turned on at CLK rising edges (corresponding to time t0, time t2, time t4, time t6). In one embodiment, the turn on for the bit switches BS0, BS2, BS4, BS6 corresponds to phase1 of one bit switch cycle or one clock cycle. Moreover, the CLK rising cell array 10022 can also generate TAU signal at phase1. Similarly, the CLK falling cell array 10024 can also utilizes CLK (XCLK) to sample the read command/addresses to make bit switches BS1, BS3, BS5, BS7 turned on at CLK falling edges (corresponding to time t1, time t3, time t5, time t7). In one embodiment, the turn on for the bit switches BS1, BS3, BS5, BS7 corresponds to phase 2 of one bit switch cycle or one clock cycle. Furthermore, the CLK falling cell array 10024 can also generate another TAU signal at phase2. In addition, as shown in FIG. 11, data Dqt0 (corresponding to time t0 and even column address A0 in this embodiment), data Dqt2 (corresponding to time t2 and even column address A2), data Dqt4 (corresponding to time t4 and even column address A4), data Dqt6 (corresponding to time t6 and even column address A6) can be read from the CLK rising cell array 10022 following turning-on of the bit switches BS0, BS2, BS4, BS6, respectively. Similarly, as shown in FIG. 11, data Dqt1 (corresponding to time t1 and odd column address A1), data Dqt3 (corresponding to time t3 and odd column address A3), data Dqt5 (corresponding to time t5 odd column address A5), data Dqt7 (corresponding to time t7 odd column address A7) can be read from the CLK falling cell array 10024 following turning-on of the bit switches BS1, BS3, BS5, BS7, respectively. In addition, TAU (phase1) and TAU (phase2) can be merged into one single DQS which tracks read data from each phase of the CLK rising cell array 10022 and the CLK falling cell array 10024. As shown in FIG. 11, data Dqt0, data Dqt1, data Dqt2, data Dqt3, data Dqt4, data Dqt5, data Dqt6, data Dqt7 correspond to column addresses (XADDR) A0, A1, A2, A3, A4, A5, A6, A7 respectively. Both the CLK rising cell array 10022 and the CLK falling cell array 10024 share the same row address, commands, controls, and slightly different column address depending on applications. For example, in one bit switch cycle or one clock cycle, the data Dqt0 at phase 1 from the even column address A0 and the data Dqt1 at phase 2 from the odd column address A1 are shared the same row address.

The write cycle:

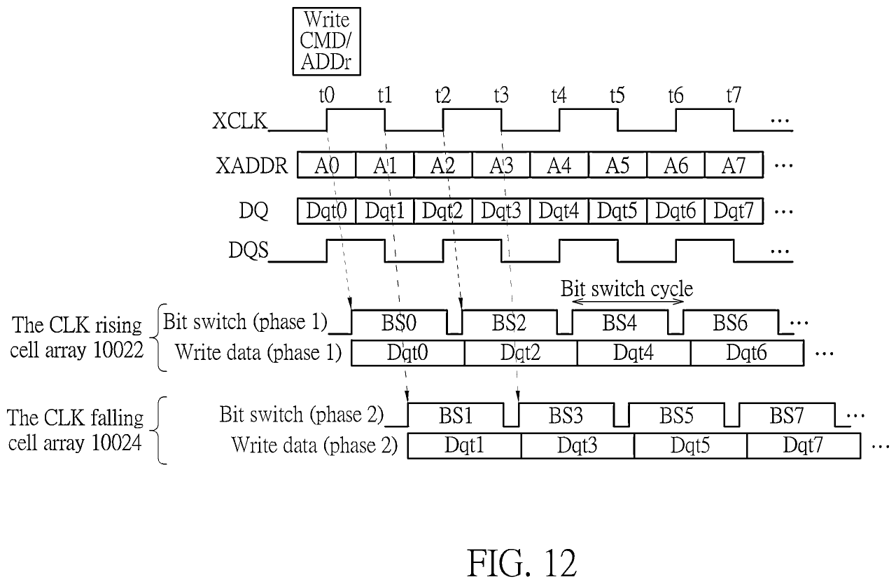

As shown in FIG. 12, after the memory chip 1002 receives write command/addresses, the CLK rising cell array 10022 can also utilizes CLK (XCLK) to sample the write command/addresses to make bit switches BS0, BS2, BS4, BS6 turned on at CLK rising edges (corresponding to time t0, time t2, time t4, time t6, each of which is phase 1 of one bit switch cycle or one clock cycle). Similarly, the CLK falling cell array 10024 can also utilizes CLK (XCLK) to sample the write command/addresses to make bit switches BS1, BS3, BS5, BS7 turned on at CLK falling edges (corresponding to time t1, time t3, time t5, time t7, each of which is phase 2 of one bit switch cycle or one clock cycle). In addition, as shown in FIG. 12, data Dqt0 (corresponding to time t0 and even column address A0), data Dqt2 (corresponding to time t2 and even column address A2), data Dqt4 (corresponding to time t4 and even column address A4), data Dqt6 (corresponding to time t6 and even column address A6) can be written into the CLK rising cell array 10022 following turning-on of the bit switches BS0, BS2, BS4, BS6, respectively. Similarly, as shown in FIG. 12, data Dqt1 (corresponding to time t1 and odd column address A1), data Dqt3 (corresponding to time t3 and odd column address A3), data Dqt5 (corresponding to time t5 and odd column address A5), data Dqt7 (corresponding to time t7 and odd column address A7) can be written into the CLK falling cell array 10024 following turning-on of the bit switches BS1, BS3, BS5, BS7, respectively. In addition, as shown in FIG. 12, DQS samples DQ in both rising edge and falling edge of the CLK (XCLK) and performs write function to the corresponding bit switches.

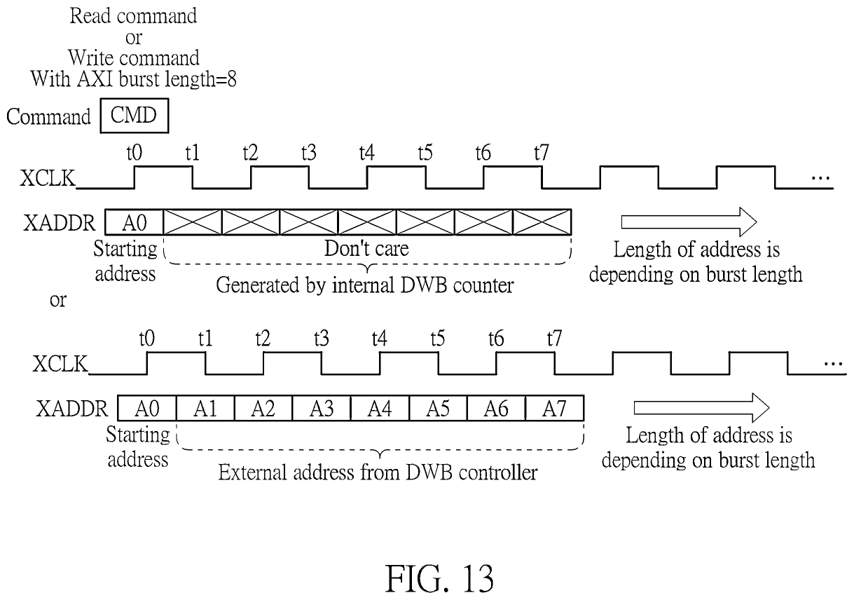

Column addresses required in FIG. 11 and/or FIG. 12 can be generated by DWB controller (such as controller 105 in FIG. 7) or internal DWB counter of the memory chip 1002. For example, in the burst read or burst write operation, with the starting address A0 and the burst length (such as length=8), the following addresses could be generated by the internal DWB counter of the memory chip 1002, as shown in the top portion of FIG. 13, wherein the burst length can be applied directly from AXI command to the controller which then may issue DWB command with the information of burst length. In another example, all the addresses A0˜A7 are generated by the DWB controller (such as controller 105 in FIG. 7), as shown in the bottom portion of FIG. 13.

Although the previous memory chip 1002 can provide multiple data rate with two phases in one bit switch cycle, it could provide normal data access with single data rate (e.g. 128 bits per CLK rising edge and no data per CLK falling edge, or 128 bits per CLK falling edge and no data per CLK rising edge) with normal bandwidth to save power (like the memory 101 shown in FIG. 7). The switch between the multiple data rate and normal data access could be set in the mode register of the memory chip 1002.

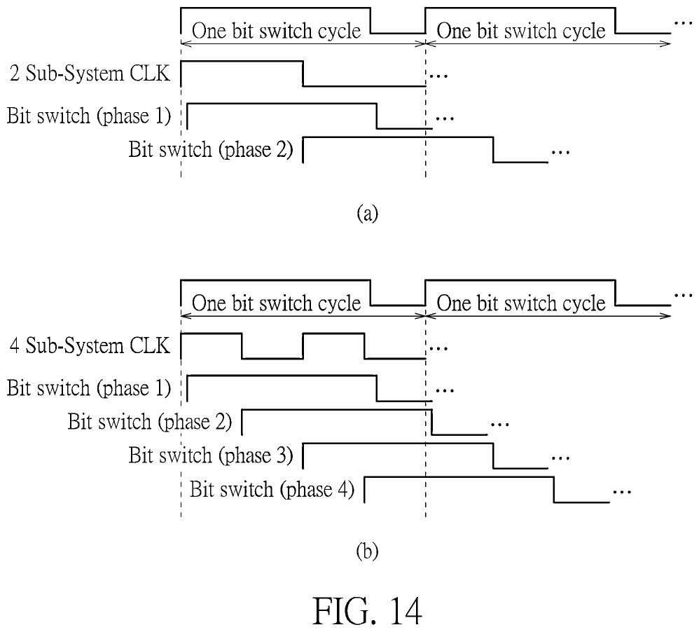

The present invention of the memory chip 1002 could be extended to multiple (more than 2) data rate or multiple phases in one bit switch cycle. Please refer to FIG. 14. As shown in FIG. 14(a), the memory chip 1002 as previous mentioned includes 2 sub-systems or two cell arrays, one CLK period equals to one bit switch cycle, and one bit switch cycle has 2 bit switch phases (phase1, phase2) which will be used to turn on two cell arrays consecutively within one bit switch cycle. On the other hand, as shown in FIG. 14(b), if the memory includes 4 sub-systems or four cell arrays, two CLK periods equals to one bit switch cycle, wherein one bit switch cycle has 4 bit switch phases (phase1, phase2, phase3, phase4) which will be used to turn on four cell arrays consecutively within one bit switch cycle.

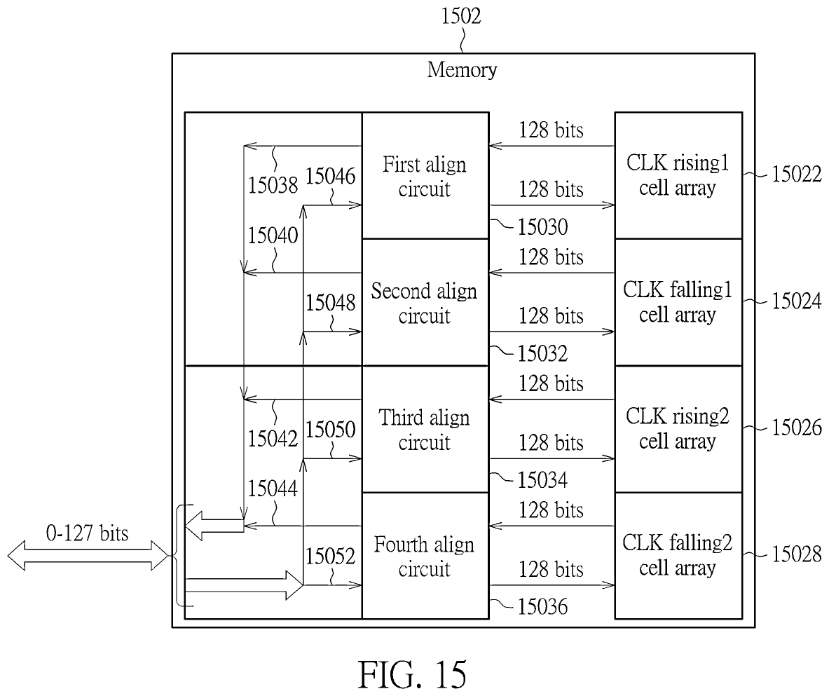

Next, please refer to FIG. 15. FIG. 15 is a diagram illustrating a memory chip 1502 with 4 sub-systems according to another embodiment of the present invention, wherein the 4 sub-systems includes a CLK rising1 cell array 15022 (e.g. BANK 0), a CLK falling1 cell array 15024 (e.g. BANK 1), a CLK rising2 cell array 15026 (e.g. BANK 2), a CLK falling2 cell array 15028 (e.g. BANK 3) to increase bandwidth or performance in some address specific applications, wherein there are 4 phases per bit switch cycle, so the memory chip 1502 has 2× faster CLK frequency than that of the memory chip 1002. In addition, the memory chip 1502 further includes a first align circuit 15030, a second align circuit 15032, a third align circuit 15034, a fourth align circuit 15036, a first direct sending data bus 15038, a second direct sending data bus 15040, a third direct sending data bus 15042, a fourth direct sending data bus 15044, a first direct receiving data bus 15046, a second direct receiving data bus 15048, a third direct receiving data bus 15050, and a fourth direct receiving data bus 15052, wherein functions of the first align circuit 15030, the second align circuit 15032, the third align circuit 15034, and the fourth align circuit 15036 are the same as that of the first align circuit 10026, so further descriptions thereof are omitted for simplicity. Similarly, functions of the first direct sending data bus 15038, the second direct sending data bus 15040, the third direct sending data bus 15042, and the fourth direct sending data bus 15044 are the same as that of the first direct sending data bus 10030, so further descriptions thereof are omitted for simplicity. In addition, functions of the first direct receiving data bus 15046, the second direct receiving data bus 15048, the third direct receiving data bus 15050, and the fourth direct receiving data bus 15052 are the same as that of the first direct receiving data bus 10034, so further descriptions thereof are also omitted for simplicity. In addition, like the CLK rising cell array 10022 and the CLK falling cell array 10024, the CLK rising1 cell array 15022, the CLK falling1 cell array 15024, the CLK rising2 cell array 15026, and the CLK falling2 cell array 15028 also share the same row addresses, commands, controls, and slightly different column address depending on applications. Again, no serial-to-parallel circuit and parallel-to-serial circuit is required between the CLK rising1 cell array 15022 (or its corresponding data line sense amplifiers) and the I/O data bus (or I/O pads), no serial-to-parallel circuit and parallel-to-serial circuit is required between the CLK falling1 cell array 15024 (or its corresponding data line sense amplifiers) and the I/O data bus (or I/O pads), no serial-to-parallel circuit and parallel-to-serial circuit is required between the CLK rising2 cell array 15026 (or its corresponding data line sense amplifiers) and the I/O data bus (or I/O pads), no serial-to-parallel circuit and parallel-to-serial circuit is required between the CLK falling2 cell array 15028 (or its corresponding data line sense amplifiers) and the I/O data bus (or I/O pads).

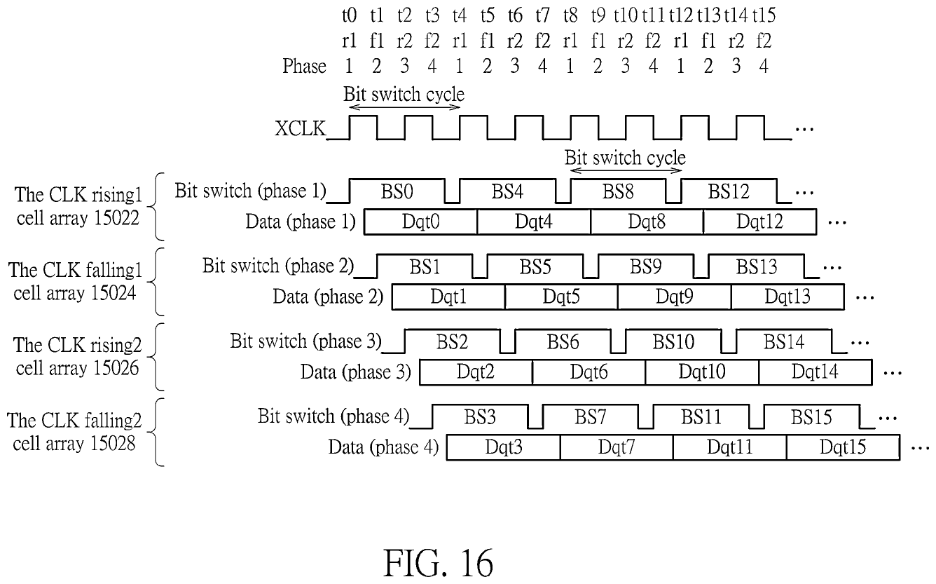

Because in the memory chip 1502, there are 4 phases per bit switch cycle which equals to 2 clock periods, in the read cycle or the write cycle, relationships between CLK (XCLK), r1 (corresponding to phase1), f1 (corresponding to phase2), r2 (corresponding to phase3), f2 (corresponding to phase4), data (phase1), data (phase2), data (phase3), and data (phase4) are shown in FIG. 16, wherein t0˜t15 represent time, r1 and r2 represent CLK rising1 edge and rising2 edge respectively, f1 and f2 represent CLK falling1 edge and CLK falling2 edge respectively, Dqt0˜Dqt15 represent data, and BS0˜BS15 represent bit switches.

For example, in one bit switch cycle between t0˜t3, at t0 & r1 (corresponding to phase1), the bit switch BS0 (may include multiple sub-bit switches) is turned on and the 128 bits data or Dqt0 of the CLK rising1 cell array 15022 could be read to the first align circuit 15030 (or 128 bits data can be written into the CLK rising1 cell array 15022 from the first align circuit 15030). At t1 & f1 (corresponding to phase2), the bit switch BS1 (may include multiple sub-bit switches) is turned on and the 128 bits data or Dqt1 of the CLK falling1 cell array 15024 could be read to the second align circuit 15032 (or 128 bits data can be written into the CLK falling1 cell array 15024 from the second align circuit 15032). Moreover, at t2 & r2 (corresponding to phase3), the bit switch BS2 (may include multiple sub-bit switches) is turned on and the 128 bits data or Dqt2 of the CLK rising2 cell array 15026 could be read to the third align circuit 15034 (or 128 bits data can be written into the CLK rising2 cell array 15022 from the third align circuit 15034). At t3 & f2 (corresponding to phase3), the bit switch BS3 (may include multiple sub-bit switches) is turned on and the 128 bits data or Dqt3 of the CLK falling2 cell array 15028 could be read to the fourth align circuit 15036 (or 128 bits data can be written into the CLK falling2 cell array 15028 from the fourth align circuit 15036). The other bit switch cycle will has the similar operations, and the detailed description of which will be skipped.

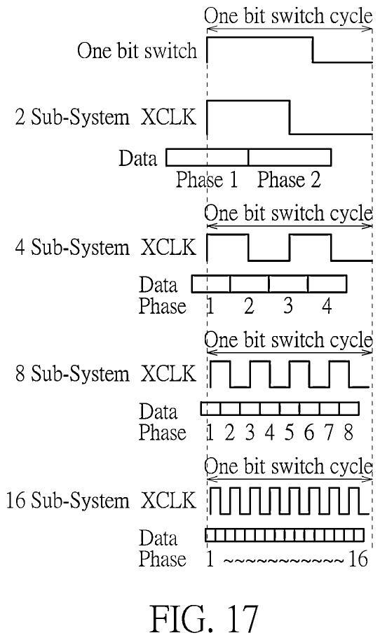

FIG. 17 is a diagram illustrating different relationships between CLK (XCLK) and data phases when a memory includes different numbers of sub-systems, wherein each sub system or cell array has the same row address, commands, controls, and slightly different column address depending on applications. As shown in FIG. 17, there are 2 phases per bit switch cycle (equal to one clock cycle) when the memory includes 2 sub-systems or cell arrays, and the corresponding PHY circuit has 2:1 serial-to-parallel circuit and parallel-to-serial circuit (or 2:1 multiplexer) to process 256 bits data (when each sub-system outputs/receives 128 bits). There are 4 phases per bit switch cycle (equal to two clock cycles) when the memory includes 4 sub-systems or cell arrays, and the corresponding PHY circuit has 4:1 serial-to-parallel circuit and parallel-to-serial circuit (or 4:1 multiplexer) to process 512 bits data (when each sub-system outputs/receives 128 bits). There are 8 phases per bit switch cycle (equal to four clock cycles) when the memory includes 8 sub-systems or cell arrays, and the corresponding PHY circuit has 8:1 serial-to-parallel circuit and parallel-to-serial circuit (or 8:1 multiplexer) to process 1024 bits data (when each sub-system outputs/receives 128 bits). There are 16phases per bit switch cycle (equal to eight clock cycles) when the memory includes 16 sub-systems and the corresponding PHY circuit has 16:1 serial-to-parallel circuit and parallel-to-serial circuit (or 16:1 multiplexer) to process 2048 bits data (when each sub-system outputs/receives 128 bits), and so on. Of course, in any case, the PHY circuit could further includes the align function circuit as previously mentioned.

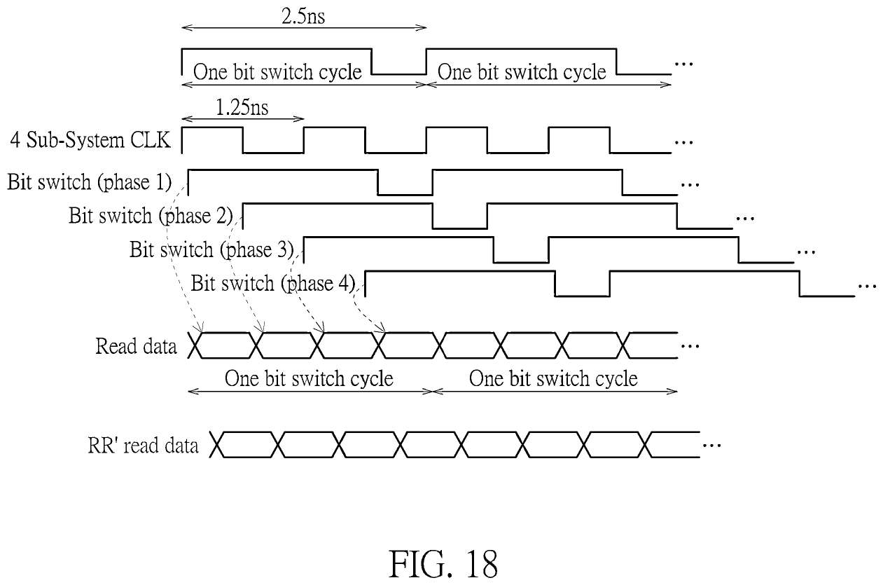

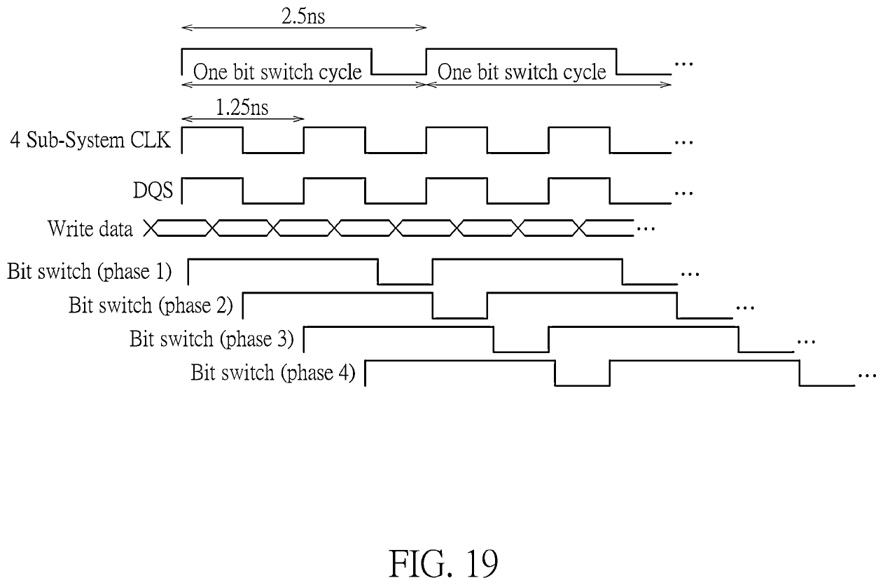

Next, please refer to FIG. 18, FIG. 19, wherein FIG. 18 is a diagram illustrating relationships between CLK (XCLK) and read data when the memory chip 1502 with 4 sub-systems, and FIG. 19 is a diagram illustrating relationships between CLK (XCLK) and write data when the memory chip 1502 with 4 sub-systems. As shown in FIG. 18, FIG. 19, there are 4 phases per bit switch cycle and one bit switch cycle (each bit switch cycle equals to 2.5 ns) equals to two CLK cycles (e.g. each CLK cycle equals to 1.25 ns). Four read data from the 4 sub-systems respectively will be read in one bit switch cycle. In addition, as shown in FIG. 18, RR′ read data represent data out which are sampled again by using CLK of DQ for better alignment. Similarly, 4 write data will be written into the 4 sub-systems respectively in one bit switch cycle, as shown in FIG. 19.

Thus, the DWB memory chip of the present invention can be built with 8, 16 . . . sub-systems, wherein the 8, 16 . . . sub-systems correspond to 8, 16 . . . phases per bit switch cycle and 4, 8 . . . CLKs (tCK) per bit switch cycle, and tCK=bit switch cycle/4, bit switch cycle/8 . . . when the memory chip 1502 (DWB memory) is built with 8, 16 . . . sub-systems, respectively. In addition, taking the bit switch cycle equaling to 2.5 ns and the width of the I/O data bus equaling to 128 bits, TABLE 4 shows relationships between numbers (1, 2, 4, 8, 16) of sub-systems, tCK and data rate, and bandwidth of the 128-bit IO data bus (channel), wherein TABLE 4 is shown as follows:

TABLE 4

| numbers of | | bandwidth of the |
|---|---|---|
| sub-systems | best tCK and data rate | 128-bit IO data bus |
| 1 | 2.5 ns, SDR, 400 Mbps | 6.4 GB/s |
| 2 | 2.5 ns, DDR, 800 Mbps | 12.8 GB/s |
| 4 | 1.25 ns, DDR, 1600 Mbps | 25.6 GB/s |
| 8 | 0.625 ns, DDR, 3200 Mbps | 51.2 GB/s |
| 16 | 0.3125 ns, DDR, 6400 Mbps | 102.4 GB/s |

In addition, in another embodiment of the present invention, a memory system can include a DWB memory chip and a SDR (single data rate) memory chip, wherein for example, the DWB memory chip has 8 sub-systems, the SDR memory chip has 4 sub-systems, operation of the DWB memory chip with 8 sub-systems can be referred to FIG. 17, and operation of the SDR memory chip with 4 sub-systems can be also referred to FIG. 17 but the SDR memory chip only operates at rising edges (or falling edges) of 8 sub-system clock (800 MHZ). Therefore, the memory system can simultaneously use the DWB memory chip and the SDR memory chip at the same 8 sub-system clock (800 MHZ). Characteristics of the memory system can be referred to TABLE 5, wherein for example, one bit switch cycle is 5 ns and clock rate of the 8 sub-system clock is 800 MHZ.

TABLE 5

| DWB memory chip | |
|---|---|
| Clock rate (MHz) | 800 |
| Data rate (Mbps), DDR | 1600 |
| Phase | 8 |
| Bit switch cycle (ns) | 5 |
| DVW = bit switch cycle/phase (ns) | 0.625 |
| SDR memory chip | |
| Clock rate (MHz) | 800 |
| Data rate (Mbps), SDR | 800 |
| Phase | 4 |
| Bit switch cycle (ns) | 5 |
| DVW = bit switch cycle/phase (ns) | 1.25 |

To sum up, the DWB memory chip with multiple sub-systems can utilize each sub-system to transmit a group data to the IO data bus (or receive a group data from the IO data bus) of the DWB memory chip in parallel. In one bit switch cycle, the group data from each sub-system could be read to the PHY circuit, or multiple group data from the PHY circuit could be written into the multiple sub-systems respectively. Therefore, without increasing the I/O bus width or I/O pin numbers of the DWB memory chip, the data rate of DWB memory chip could be increased (so is the data rate of PHY circuit to the controller), and compared to the prior art, the present invention not only can reduce powers, accessing latencies, and cost of the DWB memory chip, but also can increase bandwidth of the IO data bus and the data rate of the DWB memory chip.

Although the present invention has been illustrated and described with reference to the embodiments, it is to be understood that the invention is not to be limited to the disclosed embodiments, but on the contrary, is intended to cover various modifications and equivalent arrangements included within the spirit and scope of the appended claims.

What is claimed is:

1. A memory chip comprising:
a plurality of memory banks, each memory bank outputting or receiving a data set in parallel;
an I/O data bus; and
a plurality of align circuits corresponding to the plurality of memory banks respectively;
wherein the data set of one memory bank is transferred to one corresponding align circuit which then simultaneously transfers the data set to the I/O data bus in parallel, or the data set is transferred from the I/O data bus to the one corresponding align circuit which then simultaneously transfers the data set to the one memory bank in parallel;
wherein there is no parallel-to-serial circuit and serial-to-parallel circuit between the I/O data bus and each memory bank.

2. The memory chip of claim 1, wherein each align circuit comprises a first plurality of transceivers which connect to the I/O data bus through a direct sending/receiving bus, and a width of the I/O data bus equals to a width of the data set outputting from or receiving by each memory bank.

3. The memory chip of claim 1, wherein a plurality of the data set of the plurality of memory banks are outputted to the I/O data bus in a predetermined sequence.

4. The memory chip of claim 3, wherein the data set of each memory bank are shared with a common row address, and a column address for the data set of each memory bank are different from each other.

5. The memory chip of claim 4, wherein the column address for the data set of each memory bank is generated by the memory chip internally, or received from a memory controller external to the memory chip.

6. The memory chip of claim 3, wherein the plurality of the data set of the plurality of memory banks are outputted to the I/O data bus within a bit switch cycle which comprises a plurality of phases, and the data set of each memory bank is outputted to the I/O data bus at a corresponding phase of the bit switch cycle.

7. The memory chip of claim 6, wherein the plurality of phases of the bit switch cycle includes 2^{N} phases, and a clock period of a clock signal of the memory chip equals to the bit switch cycle divided by 2^{N-1}, and N is an integer not less than 1.

8. The memory chip of claim 6, wherein a number of the plurality of phases of the bit switch cycle is set in a mode register in the memory chip.

9. The memory chip of claim 1, further comprising:
data lines; and
a plurality set of sensing amplifiers coupled to the data lines, wherein the one memory bank corresponds to one set of sensing amplifiers, and the corresponding set of sensing amplifiers is installed between the one memory bank and the corresponding align circuit.

10. The memory chip of claim 9, wherein:
the plurality of memory banks comprise a first memory bank and a second memory bank;
the plurality set of sensing amplifiers comprise a first set of sensing amplifiers coupled to the data lines and a second set of sensing amplifiers coupled to the data lines;
the first set of sensing amplifiers corresponds to the first memory bank, and a first data set is simultaneously transferred between the first set of sensing amplifiers and the I/O data bus in parallel through an align circuit corresponding to the first memory bank;
the second set of sensing amplifiers corresponds to the second memory bank, and a second data set is simultaneously transferred between the second set of sensing amplifiers and the I/O data bus in parallel through another align circuit corresponding to the second memory bank;
a width of the I/O data bus equals to a width of the first data set and a width of the second data set.

11. The memory chip of claim 10, wherein a width of a Dfi (DDR PHY Interface) bus of a physical layer circuit of a logic circuit equals to a sum of the width of the first data set and the width of the second data set, wherein the Dfi bus is coupled between a controller within the logic circuit and the physical layer circuit, the controller is further coupled to an AXI (Advanced extensible Interface) bus outside the logic circuit, and the logic circuit is coupled to the I/O data bus of the memory chip.

12. The memory chip of claim 10, further comprising:
bit lines;
a third set of sensing amplifiers coupled to the bit lines and configured between the first memory bank and the first set of sensing amplifiers; and
a fourth set of sensing amplifiers coupled to the bit lines and configured between the second memory bank and the second set of sensing amplifiers.

13. The memory chip of claim 12, further comprising:
a first bit switch set between the first set of sensing amplifiers and the third set of sensing amplifiers; and
a second bit switch set between the second set of sensing amplifiers and the fourth set of sensing amplifiers.

14. A memory system comprising:
a first memory chip comprising:
a first plurality of memory banks, each first memory bank outputting or receiving a data set in parallel;
an I/O data bus; and
a plurality of align circuits corresponding to the first plurality of memory banks respectively;
wherein the data set of one first memory bank is transferred to one corresponding align circuit which then simultaneously transfers the data set to the I/O data bus in parallel, or the data set is transferred from the I/O data bus to the one corresponding align circuit which then simultaneously transfers the data set to the one first memory bank in parallel;
wherein there is no parallel-to-serial circuit and serial-to-parallel circuit between the I/O data bus and each first memory bank; and
a logic circuit with a physical layer circuit, wherein the logic circuit is external to and electrically connected to the I/O data bus of the first memory chip, and a parallel-to-serial circuit and a serial-to-parallel circuit are located within the physical layer circuit.

15. The memory system of claim 14, wherein the physical layer circuit further comprises a second plurality of transceivers electrically connected to the parallel-to-serial circuit and the serial-to-parallel circuit.

16. The memory system of claim 15, wherein the first plurality of memory banks comprises 2^{N} banks, N is an integer not less than 1, and the parallel-to-serial circuit is a 2^{N}:1 parallel-to-serial circuit, and the serial-to-parallel circuit is a 1:2^{N} serial-to-parallel circuit.

17. The memory system of claim 15, wherein a Dfi bus of the physical layer circuit equals to a sum of the width of the data set of each first memory bank of the first memory chip, wherein the Dfi bus is coupled between a controller within the logic circuit and the physical layer circuit.

18. The memory system of claim 14, wherein each align circuit of the first memory chip comprises a first plurality of transceivers which connect to the I/O data bus through a direct sending/receiving bus, and a width of the I/O data bus equals to a width of the data set outputting from or receiving by each first memory bank.

19. The memory system of claim 14, wherein a plurality of the data set of the first plurality of memory banks are outputted to the I/O data bus in a predetermined sequence.

20. The memory system of claim 19, wherein the data set of each first memory bank are shared with a common row address, and a column address for the data set of each first memory bank are different from each other.

21. The memory system of claim 20, wherein the column address for the data set of each first memory bank is generated by the first memory chip internally, or received from a memory controller external to the first memory chip.

22. The memory system of claim 19, wherein the plurality of the data set of the first plurality of memory banks are outputted to the I/O data bus within a bit switch cycle which comprises a plurality of phases, and the data set of each first memory bank is outputted to the I/O data bus at a corresponding phase of the bit switch cycle.

23. The memory system of claim 22, wherein the plurality of phases of the bit switch cycle includes 2^{N} phases, and a clock period of a clock signal of the first memory chip equals to the bit switch cycle divided by 2^{N-1}, and N is an integer not less than 1.

24. The memory system of claim 22, wherein a number of the plurality of phases of the bit switch cycle is set in a mode register in the first memory chip.

25. The memory system of claim 14, further comprising:
a second memory chip comprising:
a second plurality of memory banks, each second memory bank outputting or receiving a data set in parallel;
an I/O data bus; and
a plurality of align circuits corresponding to the second plurality of memory banks respectively;
wherein the data set of one second memory bank of the second memory chip is transferred to one corresponding align circuit which then simultaneously transfers the data set to the I/O data bus in parallel, or the data set of the one second memory bank of the second memory chip is transferred from the I/O data bus to the one corresponding align circuit which then simultaneously transfers the data set to the one second memory bank of the second memory chip in parallel;
wherein there is no parallel-to-serial circuit and serial-to-parallel circuit between the I/O data bus and each second memory bank of the second memory chip;
wherein a plurality of the data set of the first plurality of memory banks of the first memory chip are outputted to the I/O data bus of the first memory chip within a bit switch cycle which comprises 2^{N} phases, and the data set of each first memory bank of the first memory chip is outputted to the I/O data bus of the first memory chip at a corresponding phase of the bit switch cycle, and a clock period of a clock signal of the first memory chip equals to the bit switch cycle divided by 2^{N-1}, and N is an integer not less than 1; and
wherein the plurality of the data set of the second plurality of memory banks of the second memory chip are outputted to the I/O data bus of the second memory chip within the bit switch cycle which comprises 2^{N-1} phases, and the data set of each second memory bank of the second memory chip is outputted to the I/O data bus of the second memory chip at a corresponding phase of the bit switch cycle, and a clock period of a clock signal of the second memory chip equals to that of the first memory chip.
